(19) United States
(12) Patent Application Publication
(10) Pub. No.: US 2024/0323896 A1
(43) Pub. Date: Sep. 26, 2024

(54) ASSISTANCE DATA UPDATE PROCEDURES DURING RADIO RESOURCE CONTROL (RRC) IDLE OR INACTIVE STATE POSITIONING

(71) Applicant: QUALCOMM Incorporated, San Diego, CA (US)

(72) Inventors: Alexandros MANOLAKOS, Athens (GR); Sony AKKARAKARAN, Poway, CA (US); Srinivas YERRAMALLI, San Diego, CA (US)

(21) Appl. No.: 18/579,186

(22) PCT Filed: Aug. 3, 2022
(86) PCT No.: PCT/US2022/074451

§ 371 Date: Jan. 12, 2024

(30) Foreign Application Priority Data
Aug. 25, 2021 (GR) 20210100571

(51) Int. Cl. H04W 64/00; H04W 68/02; H04W 76/20; H04W 76/30

(52) U.S. Cl. CPC H04W 64/00; H04W 68/02; H04W 76/20; H04W 76/30

(57) ABSTRACT

Disclosed are techniques for positioning. In an aspect, a network entity receives, from a first base station of a user equipment (UE) operating in a radio resource control (RRC) inactive state, an event report message indicating that the UE has received a request to perform a positioning procedure, and transmits, based on a determination that the UE would benefit from updated positioning assistance data for the positioning procedure, the updated positioning assistance data to a second base station of the UE to enable the second base station to send the updated positioning assistance data to the UE.

### CROSS-REFERENCE TO RELATED APPLICATIONS

The present Application for Patent claims the benefit of GR application No. 20210100571, entitled “ASSISTANCE DATA UPDATE PROCEDURES DURING RADIO RESOURCE CONTROL (RRC) IDLE OR INACTIVE STATE POSITIONING”, filed Aug. 25, 2021, and is a national stage application, filed under 35 U.S.C. § 371, of International Patent Application No. PCT/US2022/074451, entitled, “ASSISTANCE DATA UPDATE PROCEDURES DURING RADIO RESOURCE CONTROL (RRC) IDLE OR INACTIVE STATE POSITIONING”, filed Aug. 3, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (IG), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of positioning performed by a network entity includes receiving, from a first base station of a user equipment (UE) operating in a radio resource control (RRC) inactive state, an event report message indicating that the UE has received a request to perform a positioning procedure; and transmitting, based on a determination that the UE would benefit from updated positioning assistance data for the positioning procedure, the updated positioning assistance data to a second base station of the UE to enable the second base station to send the updated positioning assistance data to the UE.

In an aspect, a method of positioning performed by a network node includes transmitting, to a network entity, a message indicating that a user equipment (UE) operating in a radio resource control (RRC) inactive state and engaged in a positioning procedure has moved from a coverage area of a first transmission-reception point (TRP) to a coverage area of a second TRP: receiving, from the network entity, updated positioning assistance data for the positioning procedure based on the UE having moved from the coverage area of the first TRP to the coverage area of the second TRP; and transmitting a paging message to the UE indicating to the UE that the updated positioning assistance data is available.

In an aspect, a method of positioning performed by a network node includes receiving, from a network entity, a first message indicating one or more validity criteria for each of a plurality of sets of positioning assistance data configurable to a user equipment (UE); determining that the UE has moved from a coverage area of a first transmission-reception point (TRP) to a coverage area of a second TRP, wherein the coverage area of the second TRP satisfies the one or more validity criteria for a set of positioning assistance data of the plurality of sets of positioning assistance data; and transmitting a second message to the UE indicating to the UE that the set of positioning assistance data is available.

In an aspect, a method of positioning performed by a network node includes receiving, from a network entity, updated positioning assistance data for a user equipment (UE) operating in a radio resource control (RRC) inactive state and engaged in a positioning procedure; and transmitting the updated positioning assistance data to the UE to enable the UE to perform the positioning procedure.

In an aspect, a method of wireless positioning performed by a user equipment (UE) includes transmitting, while operating in a radio resource control (RRC) inactive state, an RRC resume request to a first network node, the RRC resume request including one or more criteria indicating whether the UE needs updated positioning assistance data for a positioning procedure; and receiving, from a second network node, the updated positioning assistance data.

In an aspect, a network entity includes a memory; at least one transceiver; and at least one processor communicatively coupled to the memory and the at least one transceiver, the at least one processor configured to: receive, via the at least one transceiver, from a base station of a user equipment (UE) operating in a radio resource control (RRC) inactive state or in an RRC idle state, an event report message indicating that the UE has received a request to perform a positioning procedure; and transmit, via the at least one transceiver, based on a determination that the UE would benefit from updated positioning assistance data for the positioning procedure, the updated positioning assistance data to the base station to enable the base station to send the updated positioning assistance data to the UE.

In an aspect, a network node includes a memory; at least one transceiver; and at least one processor communicatively coupled to the memory and the at least one transceiver, the at least one processor configured to: transmit, via the at least one transceiver, to a network entity, a message indicating that a user equipment (UE) operating in a radio resource control (RRC) inactive state or in an RRC idle state and engaged in a positioning procedure has moved from a coverage area of a first transmission-reception point (TRP) to a coverage area of a second TRP; receive, via the at least one transceiver, from the network entity, updated positioning assistance data for the positioning procedure based on the UE having moved from the coverage area of the first TRP to the coverage area of the second TRP; and transmit, via the at least one transceiver, a paging message to the UE indicating to the UE that the updated positioning assistance data is available.

In an aspect, a network node includes a memory: at least one transceiver; and at least one processor communicatively coupled to the memory and the at least one transceiver, the at least one processor configured to: receive, via the at least one transceiver, from a network entity, a first message indicating one or more validity criteria for each of a plurality of sets of positioning assistance data configurable to a user equipment (UE); determine that the UE has moved from a coverage area of a first transmission-reception point (TRP) to a coverage area of a second TRP, wherein the coverage area of the second TRP satisfies the one or more validity criteria for a set of positioning assistance data of the plurality of sets of positioning assistance data; and transmit, via the at least one transceiver, a second message to the UE indicating to the UE that the set of positioning assistance data is available.

In an aspect, a network node includes a memory; at least one transceiver; and at least one processor communicatively coupled to the memory and the at least one transceiver, the at least one processor configured to: receive, via the at least one transceiver, from a network entity, updated positioning assistance data for a user equipment (UE) operating in a radio resource control (RRC) inactive state or in an RRC idle state and engaged in a positioning procedure; and transmit, via the at least one transceiver, the updated positioning assistance data to the UE to enable the UE to perform the positioning procedure.

In an aspect, a user equipment (UE) includes a memory: at least one transceiver; and at least one processor communicatively coupled to the memory and the at least one transceiver, the at least one processor configured to: transmit, via the at least one transceiver, while operating in a radio resource control (RRC) inactive state or in an RRC idle state, an RRC resume request to a first network node, the RRC resume request including one or more criteria indicating whether the UE needs updated positioning assistance data for a positioning procedure; and receive, via the at least one transceiver, from a second network node, the updated positioning assistance data.

In an aspect, a network entity includes means for receiving, from a base station of a user equipment (UE) operating in a radio resource control (RRC) inactive state or in an RRC idle state, an event report message indicating that the UE has received a request to perform a positioning procedure; and means for transmitting, based on a determination that the UE would benefit from updated positioning assistance data for the positioning procedure, the updated positioning assistance data to the base station to enable the base station to send the updated positioning assistance data to the UE.

In an aspect, a network node includes means for transmitting, to a network entity, a message indicating that a user equipment (UE) operating in a radio resource control (RRC) inactive state or in an RRC idle state and engaged in a positioning procedure has moved from a coverage area of a first transmission-reception point (TRP) to a coverage area of a second TRP; means for receiving, from the network entity, updated positioning assistance data for the positioning procedure based on the UE having moved from the coverage area of the first TRP to the coverage area of the second TRP; and means for transmitting a paging message to the UE indicating to the UE that the updated positioning assistance data is available.

In an aspect, a network node includes means for receiving, from a network entity, a first message indicating one or more validity criteria for each of a plurality of sets of positioning assistance data configurable to a user equipment (UE): means for determining that the UE has moved from a coverage area of a first transmission-reception point (TRP) to a coverage area of a second TRP, wherein the coverage area of the second TRP satisfies the one or more validity criteria for a set of positioning assistance data of the plurality of sets of positioning assistance data; and means for transmitting a second message to the UE indicating to the UE that the set of positioning assistance data is available.

In an aspect, a network node includes means for receiving, from a network entity, updated positioning assistance data for a user equipment (UE) operating in a radio resource control (RRC) inactive state or in an RRC idle state and engaged in a positioning procedure; and means for transmitting the updated positioning assistance data to the UE to enable the UE to perform the positioning procedure.

In an aspect, a user equipment (UE) includes means for transmitting, while operating in a radio resource control (RRC) inactive state or in an RRC idle state, an RRC resume request to a first network node, the RRC resume request including one or more criteria indicating whether the UE needs updated positioning assistance data for a positioning procedure; and means for receiving, from a second network node, the updated positioning assistance data.

In an aspect, a non-transitory computer-readable medium stores computer-executable instructions that, when executed by a network entity, cause the network entity to: receive, from a base station of a user equipment (UE) operating in a radio resource control (RRC) inactive state or in an RRC idle state, an event report message indicating that the UE has received a request to perform a positioning procedure; and transmit, based on a determination that the UE would benefit from updated positioning assistance data for the positioning procedure, the updated positioning assistance data to the base station to enable the base station to send the updated positioning assistance data to the UE.

In an aspect, a non-transitory computer-readable medium stores computer-executable instructions that, when executed by a network node, cause the network node to: transmit, to a network entity, a message indicating that a user equipment (UE) operating in a radio resource control (RRC) inactive state or in an RRC idle state and engaged in a positioning procedure has moved from a coverage area of a first transmission-reception point (TRP) to a coverage area of a second TRP; receive, from the network entity, updated positioning assistance data for the positioning procedure based on the UE having moved from the coverage area of the first TRP to the coverage area of the second TRP; and transmit a paging message to the UE indicating to the UE that the updated positioning assistance data is available.

In an aspect, a non-transitory computer-readable medium stores computer-executable instructions that, when executed by a network node, cause the network node to: receive, from a network entity, a first message indicating one or more validity criteria for each of a plurality of sets of positioning assistance data configurable to a user equipment (UE); determine that the UE has moved from a coverage area of a first transmission-reception point (TRP) to a coverage area of a second TRP, wherein the coverage area of the second TRP satisfies the one or more validity criteria for a set of positioning assistance data of the plurality of sets of positioning assistance data; and transmit a second message to the UE indicating to the UE that the set of positioning assistance data is available.

In an aspect, a non-transitory computer-readable medium stores computer-executable instructions that, when executed by a network node, cause the network node to: receive, from a network entity, updated positioning assistance data for a user equipment (UE) operating in a radio resource control (RRC) inactive state or in an RRC idle state and engaged in a positioning procedure; and transmit the updated positioning assistance data to the UE to enable the UE to perform the positioning procedure.

In an aspect, a non-transitory computer-readable medium stores computer-executable instructions that, when executed by a user equipment (UE), cause the UE to: transmit, while operating in a radio resource control (RRC) inactive state or in an RRC idle state, an RRC resume request to a first network node, the RRC resume request including one or more criteria indicating whether the UE needs updated positioning assistance data for a positioning procedure; and receive, from a second network node, the updated positioning assistance data.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4A is a diagram illustrating an example frame structure, according to aspects of the disclosure.

FIG. 4B is a diagram illustrating various downlink channels within an example downlink slot, according to aspects of the disclosure.

FIG. 5 illustrates an example Long-Term Evolution (LTE) positioning protocol (LPP) call flow between a UE and a location server for performing positioning operations.

FIG. 6 illustrates the different radio resource control (RRC) states available in New Radio (NR), according to aspects of the disclosure.

FIG. 7 illustrates an example four-step random access procedures, according to aspects of the disclosure.

FIG. 8 illustrates an example two-step random access procedure, according to aspects of the disclosure.

FIGS. 9A and 9B illustrate an example downlink-and-uplink-based positioning procedure for a UE in an RRC Inactive state, according to aspects of the disclosure.

FIGS. 10A and 10B illustrate an example downlink-based positioning procedure for a UE in an RRC Inactive state, according to aspects of the disclosure.

FIGS. 11 to 15 illustrate example methods of positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g . . . as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

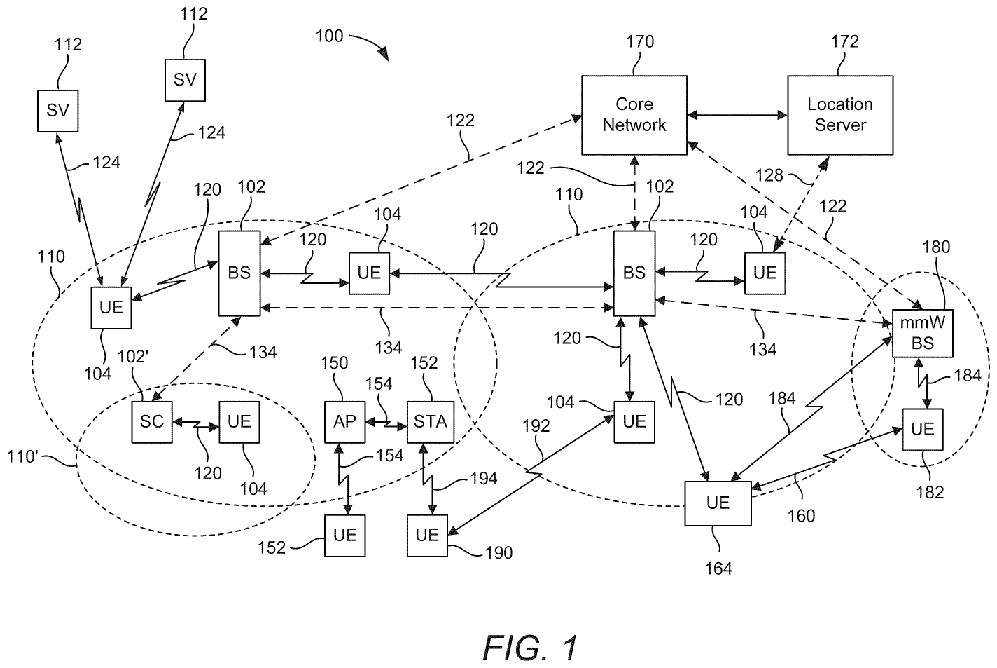

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages. NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO) antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mm W may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell.” “component carrier.” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PCS interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D). WiFi Direct (WiFi-D). Bluetooth®, and so on.

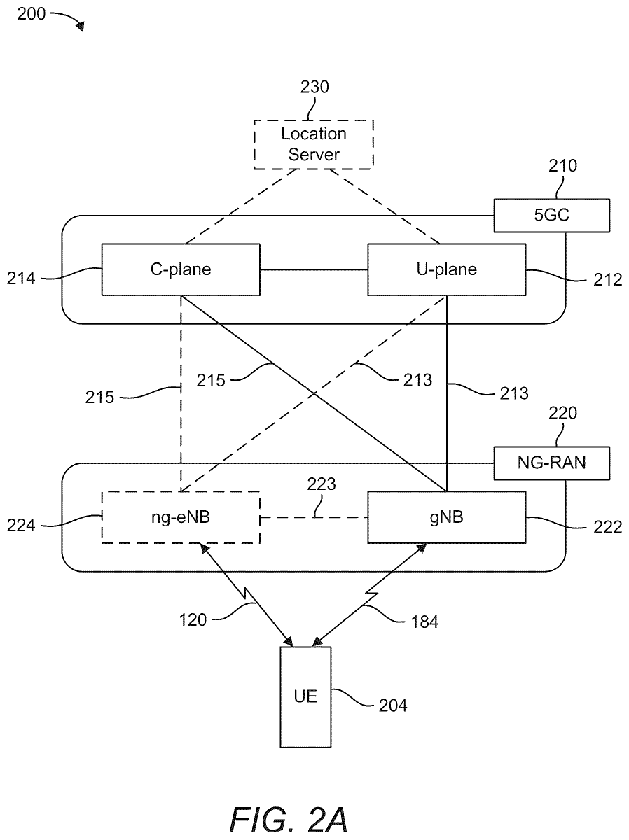

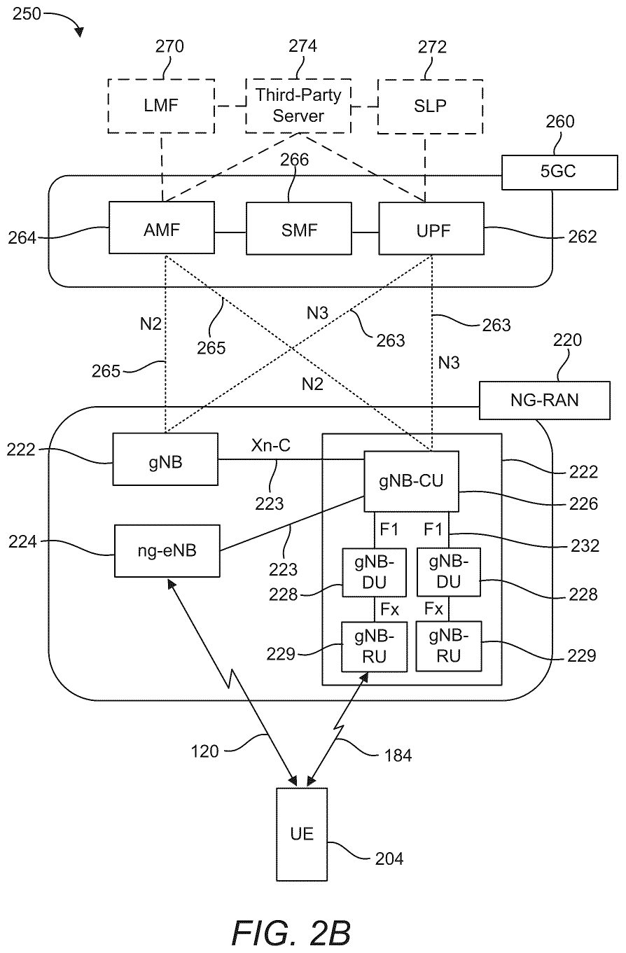

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks. IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-NB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

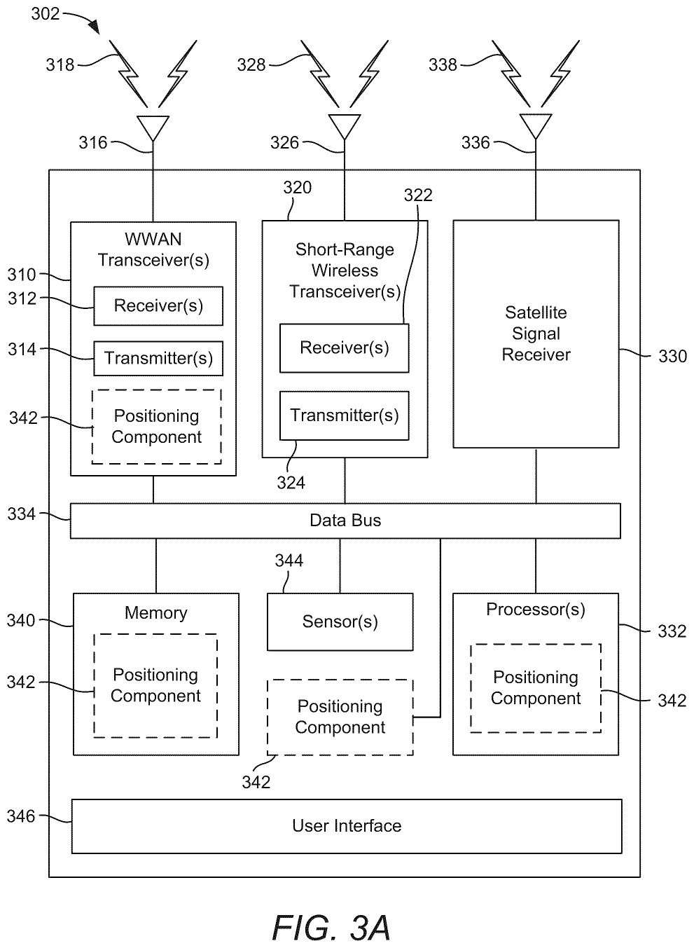

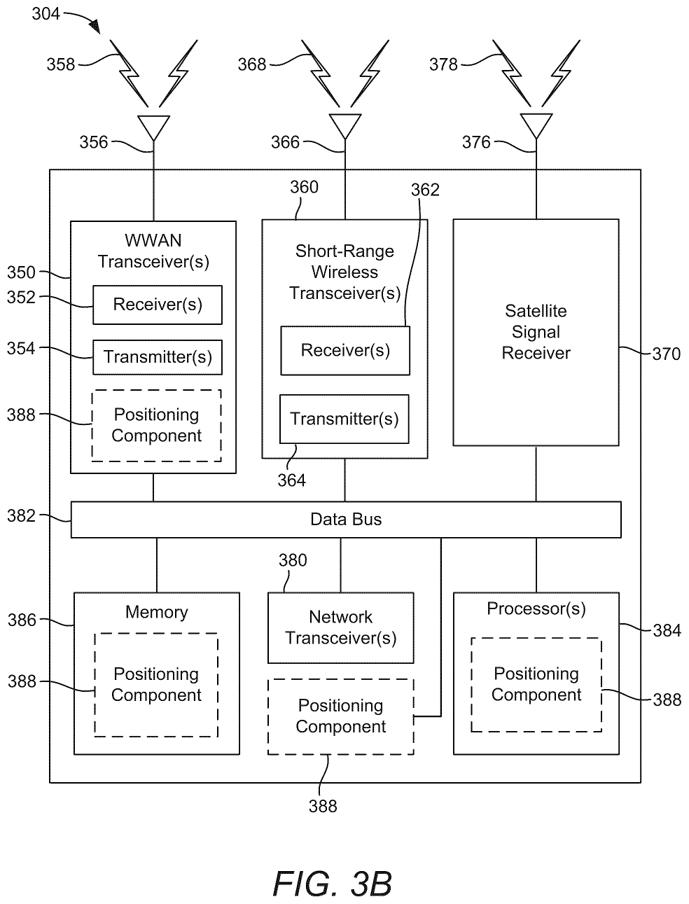

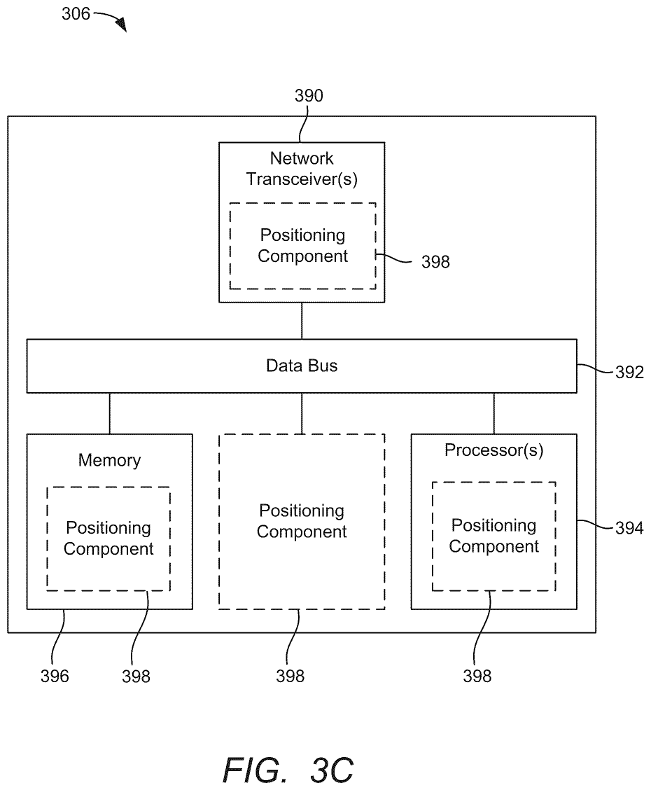

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi. LTE-D. Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth R transceivers, Zigbeek and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals. Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink. IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting: PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting: PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE.” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

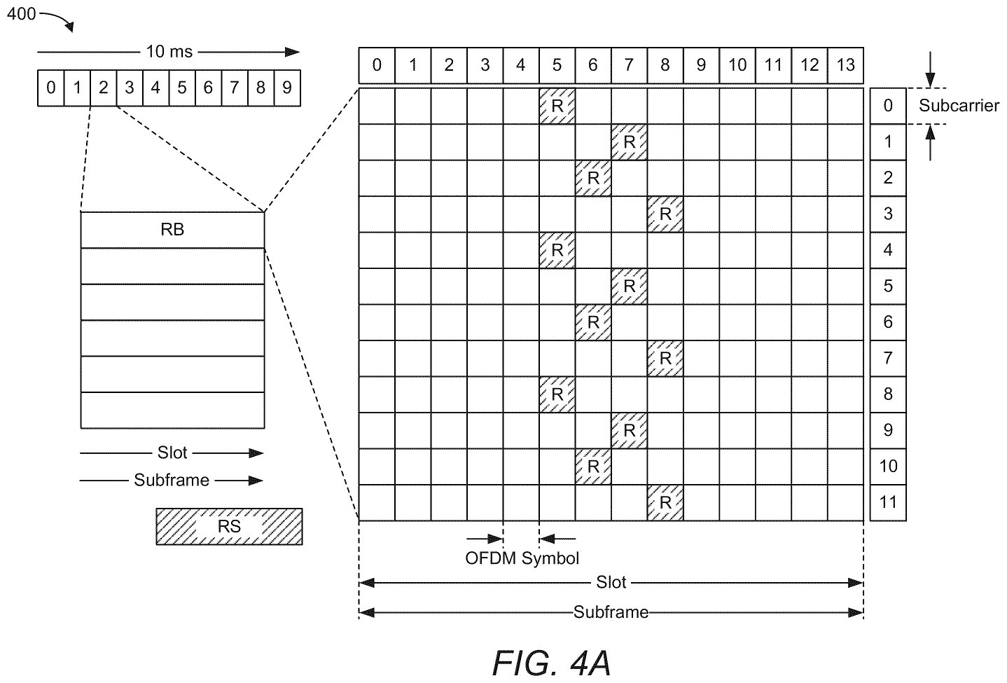

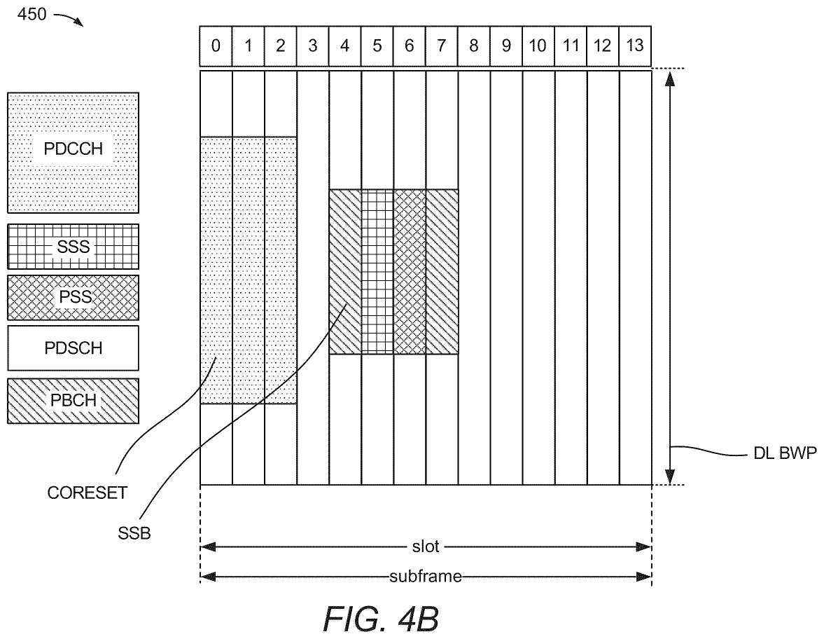

Various frame structures may be used to support downlink and uplink transmissions between network nodes (e.g., base stations and UEs). FIG. 4A is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (φ, for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe. 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4A, a numerology of 15 kHz is used. Thus, in the time domain, a 10 ms frame is divided into 10 equally sized subframes of 1 ms each, and each subframe includes one time slot. In FIG. 4A, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4A, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4A illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4A illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}: 4-symbol comb-2: {0, 1, 0, 1}: 6-symbol comb-2: {0, 1, 0, 1, 0, 1}: 12-symbol comb-2: {0, 1, 0, 1, 0, 1, 0, 1, 0, 1, 0, 1}: 4-symbol comb-4: {0, 2, 1, 3} (as in the example of FIG. 4A); 12-symbol comb-4: {0, 2, 1, 3, 0, 2, 1, 3, 0, 2, 1, 3}: 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2∧μ* {4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource.” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion.” a “PRS positioning instance, a “positioning occasion.” “a positioning instance.” a “positioning repetition.” or simply an “occasion,” an “instance.” or a “repetition.”

A “positioning frequency layer” (also referred to simply as a “frequency laver”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to. PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS. PTRS), the signals may be prepended with “UL” or “DL” to distinguish the direction. For example, “UL-DMRS” may be differentiated from “DL-DMRS.”

FIG. 4B is a diagram 450 illustrating various downlink channels within an example downlink slot. In FIG. 4B, time is represented horizontally (on the X axis) with time increasing from left to right, while frequency is represented vertically (on the Y axis) with frequency increasing (or decreasing) from bottom to top. In the example of FIG. 4B, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 4B, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 4B, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 4B is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, the positioning entity uses a beam report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE. For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest subframe boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

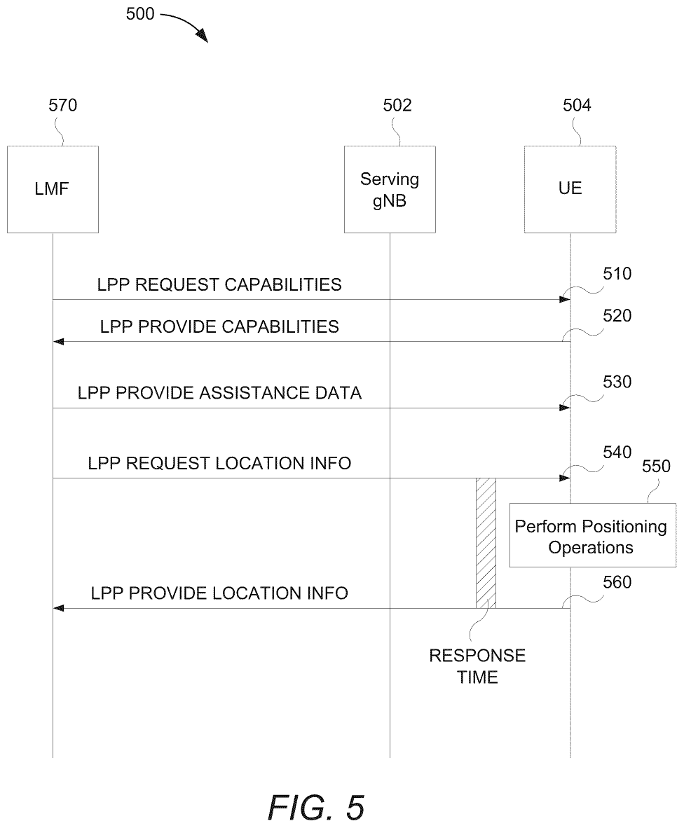

FIG. 5 illustrates an example Long-Term Evolution (LTE) positioning protocol (LPP) procedure 500 between a UE 504 and a location server (illustrated as a location management function (LMF) 570) for performing positioning operations. As illustrated in FIG. 5, positioning of the UE 504 is supported via an exchange of LPP messages between the UE 504 and the LMF 570. The LPP messages may be exchanged between UE 504 and the LMF 570 via the UE's 504 serving base station (illustrated as a serving gNB 502) and a core network (not shown). The LPP procedure 500 may be used to position the UE 504 in order to support various location-related services, such as navigation for UE 504 (or for the user of UE 504), or for routing, or for provision of an accurate location to a public safety answering point (PSAP) in association with an emergency call from UE 504 to a PSAP, or for some other reason. The LPP procedure 500 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 504 may receive a request for its positioning capabilities from the LMF 570 at stage 510 (e.g., an LPP Request Capabilities message). At stage 520, the UE 504 provides its positioning capabilities to the LMF 570 relative to the LPP protocol by sending an LPP Provide Capabilities message to LMF 570 indicating the position methods and features of these position methods that are supported by the UE 504 using LPP. The capabilities indicated in the LPP Provide Capabilities message may, in some aspects, indicate the type of positioning the UE 504 supports (e.g., DL-TDOA, RTT, E-CID, etc.) and may indicate the capabilities of the UE 504 to support those types of positioning.

Upon reception of the LPP Provide Capabilities message, at stage 520, the LMF 570 determines to use a particular type of positioning method (e.g., DL-TDOA, RTT, E-CID, etc.) based on the indicated type(s) of positioning the UE 504 supports and determines a set of one or more transmission-reception points (TRPs) from which the UE 504 is to measure downlink positioning reference signals or towards which the UE 504 is to transmit uplink positioning reference signals. At stage 530, the LMF 570 sends an LPP Provide Assistance Data message to the UE 504 identifying the set of TRPs.

In some implementations, the LPP Provide Assistance Data message at stage 530 may be sent by the LMF 570 to the UE 504 in response to an LPP Request Assistance Data message sent by the UE 504 to the LMF 570 (not shown in FIG. 5). An LPP Request Assistance Data message may include an identifier of the UE's 504 serving TRP and a request for the positioning reference signal (PRS) configuration of neighboring TRPs.

At stage 540, the LMF 570 sends a request for location information to the UE 504. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 530 may be sent after the LPP Request Location Information message at 540 if, for example, the UE 504 sends a request for assistance data to LMF 570 (e.g., in an LPP Request Assistance Data message, not shown in FIG. 5) after receiving the request for location information at stage 540.

At stage 550, the UE 504 utilizes the assistance information received at stage 530 and any additional data (e.g., a desired location accuracy or a maximum response time) received at stage 540 to perform positioning operations (e.g., measurements of DL-PRS, transmission of UL-PRS, etc.) for the selected positioning method.

At stage 560, the UE 504 may send an LPP Provide Location Information message to the LMF 570 conveying the results of any measurements that were obtained at stage 550 (e.g., time of arrival (ToA), reference signal time difference (RSTD), reception-to-transmission (Rx-Tx), etc.) and before or when any maximum response time has expired (e.g., a maximum response time provided by the LMF 570 at stage 540). The LPP Provide Location Information message at stage 560 may also include the time (or times) at which the positioning measurements were obtained and the identity of the TRP(s) from which the positioning measurements were obtained. Note that the time between the request for location information at 540 and the response at 560 is the “response time” and indicates the latency of the positioning session.

The LMF 570 computes an estimated location of the UE 504 using the appropriate positioning techniques (e.g., DL-TDOA, RTT, E-CID, etc.) based, at least in part, on measurements received in the LPP Provide Location Information message at stage 560.

After a random access procedure, the UE is in an RRC CONNECTED state. The RRC protocol is used on the air interface between a UE and a base station. The major functions of the RRC protocol include connection establishment and release functions, broadcast of system information, radio bearer establishment, reconfiguration, and release, RRC connection mobility procedures, paging notification and release, and outer loop power control. In LTE, a UE may be in one of two RRC states (CONNECTED or IDLE), but in NR, a UE may be in one of three RRC states (CONNECTED, IDLE, or INACTIVE). The different RRC states have different radio resources associated with them that the UE can use when it is in a given state. Note that the different RRC states are often capitalized, as above; however, this is not necessary, and these states can also be written in lowercase.

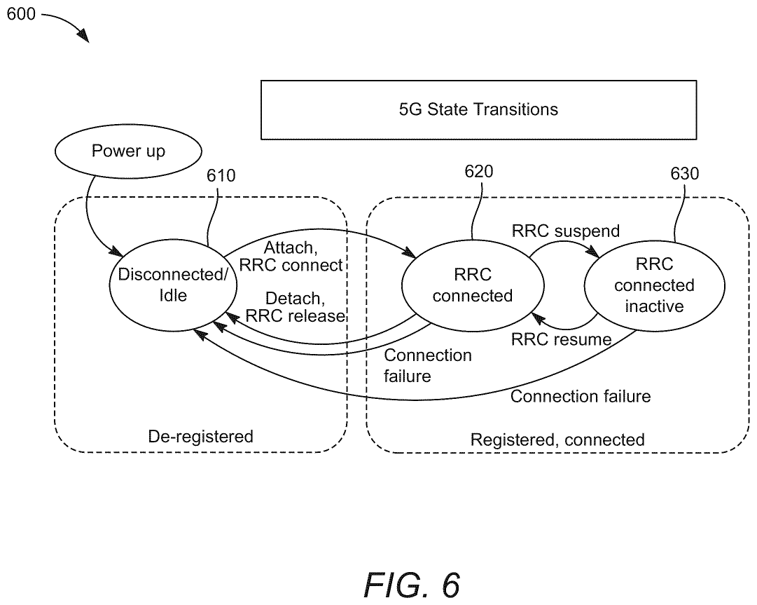

FIG. 6 is a diagram 600 of the different RRC states (also referred to as RRC modes) available in NR, according to aspects of the disclosure. When a UE is powered up, it is initially in the RRC DISCONNECTED/IDLE state 610. After a random access procedure, it moves to the RRC CONNECTED state 620. If there is no activity at the UE for a short time, it can suspend its session by moving to the RRC INACTIVE state 630. The UE can resume its session by performing a random access procedure to transition back to the RRC CONNECTED state 620. Thus, the UE needs to perform a random access procedure to transition to the RRC CONNECTED state 620, regardless of whether the UE is in the RRC IDLE state 610 or the RRC INACTIVE state 630.

The operations performed in the RRC IDLE state 610 include public land mobile network (PLMN) selection, broadcast of system information, cell re-selection mobility, paging for mobile terminated data (initiated and managed by the 5GC), discontinuous reception (DRX) for core network paging (configured by non-access stratum (NAS)). The operations performed in the RRC CONNECTED state 620 include 5GC (e.g., 5GC 260) and NG-RAN (e.g., NG-RAN 220) connection establishment (both control and user planes), UE context storage at the NG-RAN and the UE. NG-RAN knowledge of the cell to which the UE belongs, transfer of unicast data to/from the UE, and network controlled mobility. The operations performed in the RRC INACTIVE state 630 include the broadcast of system information, cell re-selection for mobility, paging (initiated by the NG-RAN). RAN-based notification area (RNA) management (by the NG-RAN), DRX for RAN paging (configured by the NG-RAN), 5GC and NG-RAN connection establishment for the UE (both control and user planes), storage of the UE context in the NG-RAN and the UE, and NG-RAN knowledge of the RNA to which the UE belongs.

Paging is the mechanism whereby the network informs the UE that it has data for the UE. In most cases, the paging process occurs while the UE is in the RRC IDLE state 610 or the RRC INACTIVE state 630. This means that the UE needs to monitor whether the network is transmitting any paging message to it. For example, during the RRC IDLE state 610, the UE enters the sleep mode defined in its DRX cycle. The UE periodically wakes up and monitors its paging frame (PF) and paging occasion (PO) within that PF on the PDCCH to check for the presence of a paging message. The PF and PO indicate the time period (e.g., one or more symbols, slots, subframes, etc.) during which the RAN (e.g., serving base station/TRP/cell) will transmit any pages to the UE, and therefore, the time period during which the UE should monitor for pages. As will be appreciated, the PF and PO are configured to occur periodically, specifically, at least once during each DRX cycle (which is equal to the paging cycle). Although both the PF and PO are needed to determine the time at which to monitor for pages, for simplicity, often only the PO is referenced. If the PDCCH, via the PF and PO, indicates that a paging message is transmitted in the subframe, then the UE needs to demodulate the paging channel (PCH) on the PDSCH to see if the paging message is directed to it.

The PDCCH and PDSCH are transmitted using beam sweeping and repetition. For beam sweeping, within each PO, the paging PDCCH and PDSCH are transmitted on all SSB beams for SSBs transmitted in the cell. This is because when the UE is in the RRC IDLE state 610 or the RRC INACTIVE state 630, the base station does not know where in its geographic coverage area the UE is located, and therefore needs to beamform over its entire geographic coverage area. For repetition, the paging PDCCH and PDSCH can be transmitted multiple times on each beam within the PO. Therefore, each PO contains multiple consecutive paging PDCCH monitoring occasions (PMOs).

Legacy UE's are expected to monitor all POs in their paging cycle (typically one PO per paging cycle per UE). In NR, however, the network (e.g., serving base station) can transmit a page indication (PI) to a UE during a monitoring occasion ahead of a PO. The PI indicates whether the UE is paged in the upcoming PO. Specifically, if the PI indicates that the UE is not paged, the UE does not need to decode the paging PDCCH and PDSCH. Only if the PI indicates that the UE is paged does the UE continue to decode the paging PDCCH and PDSCH.

In order to establish uplink synchronization and an RRC connection with a base station (or more specifically, a serving cell/TRP), a UE needs to perform a random access procedure (also referred to as a random access channel (RACH) procedure or a physical random access channel (PRACH) procedure). There are two types of random access available in NR, contention based random access (CBRA), also referred to as “four-step” random access, and contention free random access (CFRA), also referred to as “three-step” random access. There is also a “two-step” random access procedure that may be performed instead of the four-step random access procedure in certain cases.

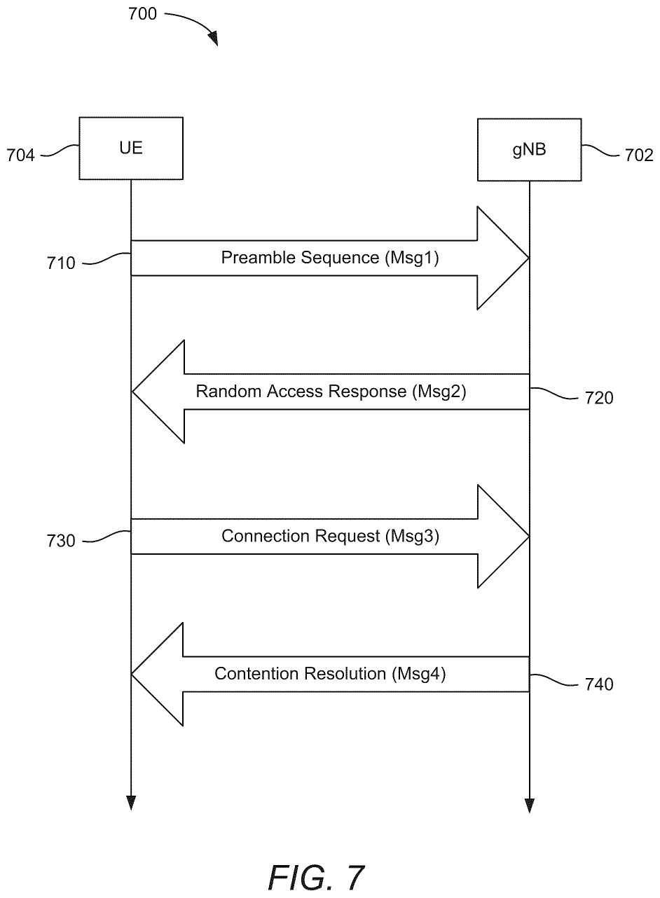

FIG. 7 illustrates an example four-step random access procedure 700, according to aspects of the disclosure. The four-step random access procedure 700 is performed between a UE 704 and a base station 702 (illustrated as a gNB), which may correspond to any of the UEs and base stations, respectively, described herein.

There are various situations in which a UE 704 may perform the four-step random access procedure 700. For example, a UE 704 may perform the four-step random access procedure 700 when performing an initial RRC connection setup (i.e., acquiring initial network access after coming out of the RRC IDLE state), when performing an RRC connection re-establishment procedure, when the UE 704 has uplink data to transmit, when the UE 704 has uplink data to transmit and the UE 704 is in an RRC CONNECTED state but there are no PUCCH resources available for a scheduling request (SR), or when there is a scheduling request failure.

Before performing the four-step random access procedure 700, the UE 704 reads one or more synchronization signal blocks (SSBs) broadcasted by the base station 702 with which the UE 704 is performing the four-step random access procedure 700. In NR, each beam transmitted by a base station (e.g., base station 702) is associated with a different SSB, and a UE (e.g., UE 704) selects a certain beam to use to communicate with the base station 702. Based on the SSB of the selected beam, the UE 704 can then read the system information block (SIB) type 1 (SIB1), which carries cell access related information and supplies the UE 704 with the scheduling of other system information blocks transmitted on the selected beam.

When the UE 704 sends the very first message of the four-step random access procedure 700 to the base station 702, it sends a specific pattern called a “preamble” (also referred to as a “RACH preamble.” a “PRACH preamble,” a “sequence”). The preamble differentiates requests from different UEs 704. In CBRA, a UE 704 selects a preamble randomly from a pool of preambles (64 in NR) shared with other UEs 704. However, if two UEs 704 use the same preamble at the same time, then there can be a collision, or contention.

Thus, at 710, the UE 704 selects one of the 64 preambles to send to the base station 702 as a RACH request (also referred to as a “random access request”). This message is referred to as “Message 1” or “Msg1” in a four-step random access procedure 700. Based on the synchronization information from the base station 702 (e.g., the SIB1), the UE 704 sends the preamble at the RACH occasion (RO) corresponding to the selected SSB/beam. More specifically, in order for the base station 702 to determine which beam the UE 704 has selected, a specific mapping is defined between an SSB and an RO (which occur every 10, 20, 40, 80, or 160 ms). By detecting at which RO the UE 704 sent the preamble, the base station 702 can determine which SSB/beam the UE 704 selected.

Note that an RO is a time-frequency transmission opportunity for transmitting a preamble, and a preamble index (i.e., a value from 0 to 63 for the 64 possible preambles) enables the UE 704 to generate the type of preamble expected at the base station 702. The RO and preamble index may be configured to the UE 704 by the base station 702 in a SIB. A RACH resource is an RO in which one preamble index is transmitted. As such, the terms “RO” (or “RACH occasion”) and “RACH resource” may be used interchangeably, depending on the context.

Due to reciprocity, the UE 704 may use the uplink transmit beam corresponding to the best downlink receive beam determined during synchronization (i.e., the best receive beam to receive the selected downlink beam from the base station 702). That is, the UE 704 uses the parameters of the downlink receive beam used to receive the SSB beam from the base station 702 to determine the parameters of the uplink transmit beam. If reciprocity is available at the base station 702, the UE 704 can transmit the preamble over one beam. Otherwise, the UE 704 repeats transmission of the same preamble on all of its uplink transmit beams.

The UE 704 also needs to provide its identity to the network (via base station 702) so that the network can address it in the next step. This identity is called the random access radio network temporary identity (RA-RNTI) and is determined from the time slot in which the preamble is sent.

If the UE 704 does not receive a response from the base station 702 within some period of time, it increases its transmission power by a fixed step and sends the preamble/Msg1 again. More specifically, the UE 704 transmits a first set of repetitions of the preamble, then, if it does not receive a response, it increases its transmission power and transmits a second set of repetitions of the preamble. The UE 704 continues increasing its transmit power in incremental steps until it receives a response from the base station 702.

At 720, the base station 702 sends a random access response (RAR), referred to as a “Message 2” or “Msg2” in a four-step random access procedure 700, to the UE 704 on the selected beam. The RAR is sent on a physical downlink shared channel (PDSCH) and is addressed to the RA-RNTI calculated from the time slot (i.e., RO) in which the preamble was sent. The RAR carries the following information: a cell-radio network temporary identifier (C-RNTI), a timing advance (TA) value, and an uplink grant resource. The base station 702 assigns the C-RNTI to the UE 704 to enable further communication with the UE 704. The TA value specifies how much the UE 704 should change its timing to compensate for the propagation delay between the UE 704 and the base station 702. The uplink grant resource indicates the initial resources the UE 704 can use on the physical uplink shared channel (PUSCH). After this step, the UE 704 and the base station 702 establish coarse beam alignment that can be utilized in the subsequent steps.

At 730, using the allocated PUSCH, the UE 704 sends an RRC connection request message, referred to as a “Message 3” or “Msg3,” to the base station 702. Because the UE 704 sends the Msg3 over the resources scheduled by the base station 702, the base station 702 knows from where (spatially) to detect the Msg3 and therefore which uplink receive beam should be used. Note that the Msg3 PUSCH can be sent on the same or different uplink transmit beam as the Msg1.

The UE 704 identifies itself in the Msg3 by the C-RNTI assigned in the previous step. The message contains the UE's 704 identity and connection establishment cause. The UE's 704 identity is either a temporary mobile subscriber identity (TMSI) or a random value. A TMSI is used if the UE 704 has previously connected to the same network. The UE 704 is identified in the core network by the TMSI. A random value is used if the UE 704 is connecting to the network for the very first time. The reason for the random value or TMSI is that the C-RNTI may have been assigned to more than one UE 704 in the previous step, due to multiple requests arriving at the same time. The connection establishment cause indicates the reason why the UE 704 needs to connect to the network (e.g., for a positioning session, because it has uplink data to transmit, because it received a page from the network, etc.).

As noted above, the four-step random access procedure 700 is a CBRA procedure. Thus, as described above, any UE 704 connecting to the same base station 702 can send the same preamble at 710, in which case, there is a possibility of collision, or contention, among the requests from the various UEs 704. Accordingly, the base station 702 uses a contention resolution mechanism to handle this type of access request. In this procedure, however, the result is random and not all random access succeeds.

Thus, at 740, if the Msg3 was successfully received, the base station 702 responds with a contention resolution message, referred to as a “Message 4” or “Msg4.” This message is addressed to the TMSI or random value (from the Msg3) but contains a new C-RNTI that will be used for further communication. Specifically, the base station 702 sends the Msg4 in the PDSCH using the downlink transmit beam determined in the previous step.

As shown in FIG. 7, the four-step random-access procedure 700 requires two round-trip cycles between the UE 704 and the base station 702, which not only increases latency but also incurs additional control signaling overhead. To address these issues, two-step random access has been introduced in NR for CBRA. The motivation behind two-step random access is to reduce latency and control signaling overhead by having a single round trip cycle between a UE and a base station. This is achieved by combining the preamble (Msg1) and the scheduled PUSCH transmission (Msg3) into a single message from the UE to the base station, known as “MsgA.” Similarly, the random access response (Msg2) and the contention resolution message (Msg4) are combined into a single message from the base station to the UE, known as “MsgB.” This reduces latency and control signaling overhead.

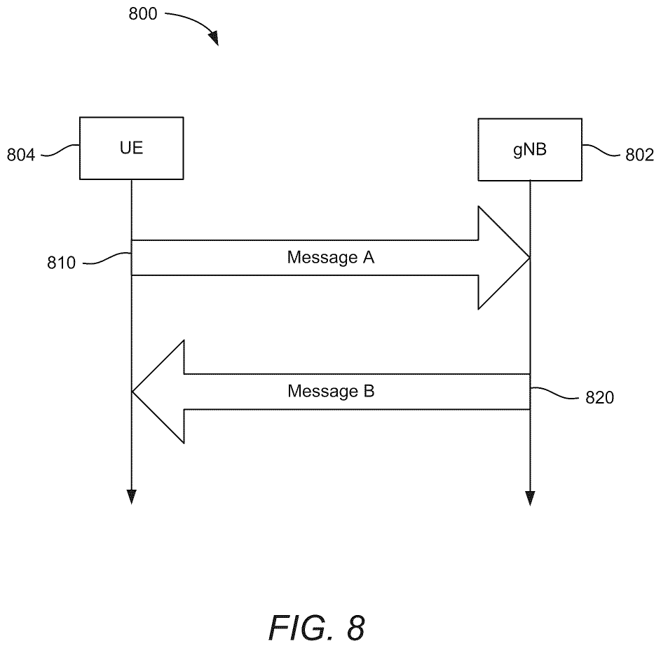

FIG. 8 illustrates an example two-step random access procedure 800, according to aspects of the disclosure. The two-step random access procedure 800 may be performed between a UE 804 and a base station 802 (illustrated as a gNB), which may correspond to any of the UEs and base stations, respectively, described herein.

At 810, the UE 804 transmits a RACH Message A (“MsgA”) to the base station 802. In a two-step random access procedure 800, Msg1 and Msg3, described above with reference to FIG. 7, are collapsed (i.e., combined) into a MsgA and sent to the base station 802. As such, a MsgA includes a preamble and a PUSCH similar to the Msg3 PUSCH of a four-step random access procedure 700. The preamble may have been selected from the 64 possible preambles, as described above with reference to FIG. 7, and may be used as a reference signal for demodulating the data transmitted in the MsgA. At 820, the UE 804 receives a RACH Message B (“MsgB”) from the base station 802. The MsgB may be a combination of Msg2 and Msg4 described above with reference to FIG. 7.

The combination of Msg1 and Msg3 into one MsgA and the combination of Msg2 and Msg4 into one MsgB allows the UE 804 to reduce the RACH procedure setup time to support the low-latency requirements of NR. Although the UE 804 may be configured to support the two-step random access procedure 800, the UE 804 may still support the four-step random access procedure 700 as a fall back if the UE 804 is not able to use the two-step random access procedure 800 due to some constraints (e.g., high transmit power requirements, etc.). Therefore, a UE 804 in NR may be configured to support both the four-step and the two-step random access procedures 700 and 800, and may determine which random access procedure to use based on the RACH configuration information received from the base station 802.

Currently, NR positioning is only supported for UEs in an RRC Connected state (e.g., RRC CONNECTED state 620). A UE in an RRC Idle state (e.g., RRC DISCONNECTED/IDLE state 610) or an RRC Inactive state (e.g., RRC INACTIVE state 630) has to transition to an RRC Connected state whenever positioning operations are to be performed. This mechanism increases the UE's power consumption, positioning latency, and network load. As such, support for positioning for UEs in an RRC Idle or Inactive state is one of the enhancement areas for future positioning-related standards. However, how to configure a UE to receive DL-PRS and transmit SRS for positioning while in an RRC Idle or Inactive state has not been defined. Prior solutions have proposed to preconfigure a UE with the necessary PRS and/or SRS configuration(s) when the UE is in an RRC Connected state so that it can use those configurations for positioning in the RRC Idle or Inactive state.

Two topics are being considered with the potential of one feature (i.e., small data transmission (SDT)) being used by the other feature (i.e., positioning). SDT has been defined for UEs in RRC Inactive mode. When configured for SDT. UEs in an RRC Inactive state are configured to transmit small data packets to the serving base station without the UE transitioning to an RRC Connected state for the transmission of each small packet (which may arrive sparsely). SDT provides a power saving feature, and is expected to be used primarily for stationary UEs. Thus, SDT techniques do not support mobility across cells, closed loop power control, timing advance (TA) adjustment, and the like for RRC Inactive mode, even if the UE moves around within the coverage area of a cell.

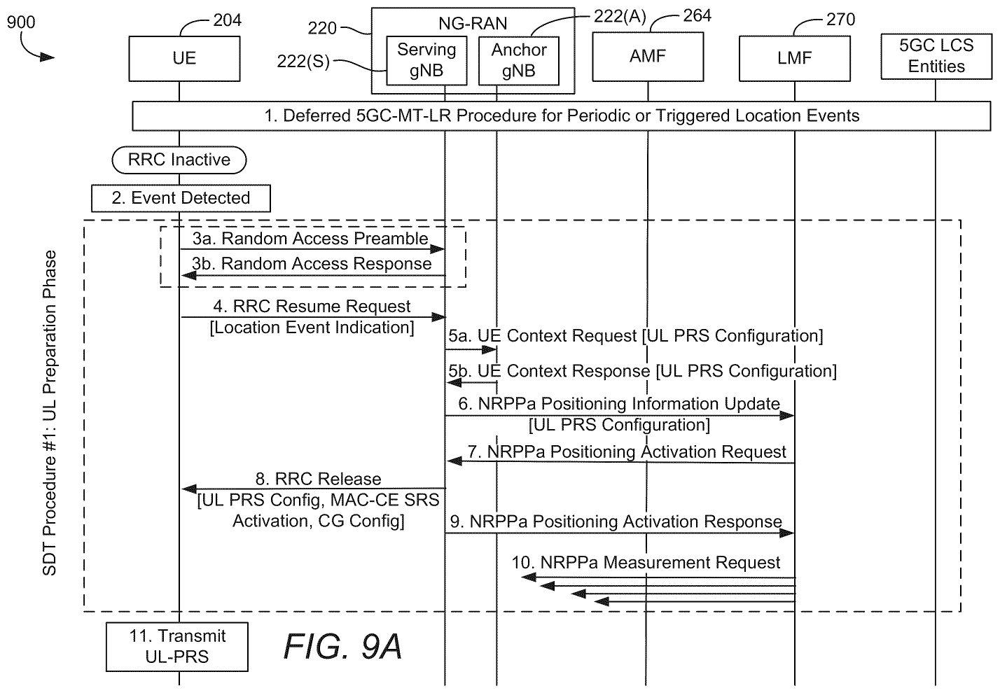

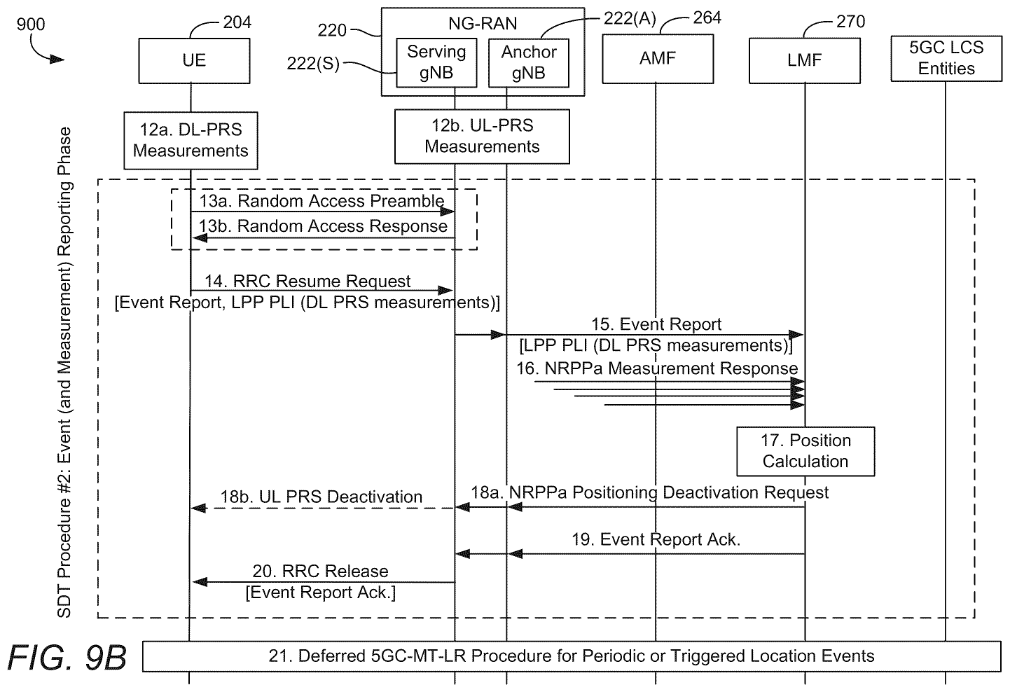

FIGS. 9A and 9B illustrate an example downlink-and-uplink-based positioning procedure 900 for a UE in an RRC Inactive state, according to aspects of the disclosure. The positioning procedure 900 is split into two SDT procedures, an uplink (UL) preparation phase, illustrated in FIG. 9A, and an event and measurement reporting phase, illustrated in FIG. 9B.

At stage 1, the UE 204 performs stages 1 to 21 of a deferred 5GC mobile-terminated location request (5GC-MT-LR) procedure for periodic or triggered location events, as defined in 3GPP Technical Specification (TS) 23.273 (which is publicly available and incorporated by reference herein in its entirety). At stage 2, the UE 204 detects an event and, in response, at stage 3a, sends a random access (RA) preamble to the serving gNB 222(S) (e.g., as at stage 710 of FIG. 7). At stage 3b, the UE 204 receives a random access response from the serving gNB 222(S) (e.g., as at stage 720 of FIG. 7), causing the UE 204, at stage 4, to send an RRC Resume Request to the serving gNB 222(S). The RRC Resume Request may include a location event indication. The UE 204 is now in an RRC Connected state.

At stage 5a, the serving gNB 222(S) sends a UE context request for an UL-PRS configuration for the UE 204 to the anchor gNB 222(A) (a gNB from which the UE 204 receives pages while in RRC Inactive mode; a UE 204 could have multiple anchor gNBs 222(A) due to mobility). At stage 5b, the serving gNB 222(S) receives a context response including an UL-PRS configuration for the UE 204 from the anchor gNB 222(A). At stage 6, the serving gNB 222(S) sends an NR positioning protocol type A (NRPPa) Positioning Information Update message (including UL-PRS configuration) to the LMF 270. At stage 7, the LMF 270 sends an NRPPa Positioning Activation Request to the gNB 222(S). At stage 8, the serving gNB 222(S) sends an RRC Release message to the UE 204, causing the UE 204 to transition back into an RRC Inactive state. The RRC Release message includes the UL-PRS configuration, a MAC control element (MAC-CE) SRS activation, and a configured grant (CG) configuration (to transmit DL-PRS measurements). At stage 9, the serving gNB 222(S) sends an NRPPa Positioning Activation Response to the LMF 270. At stage 10, the LMF 270 sends NRPPa Measurement Request messages to each involved gNB 222 in the NG-RAN 220.

After the uplink preparation phase is completed, the UE 204 is again in an RRC Inactive state. At stage 11, the UE 204 transmits UL-PRS according to the UL-PRS configuration received at stage 8. At stage 12a, the UE 204 performs measurements of DL-PRS resources (sometimes referred to as “DL-PRS measurements”) transmitted by the gNBs 222 in the NG-RAN 220. In the positioning procedure 900, the UE 204 has been previously configured with the DL-PRS resources to be measured at stage 12a. At stage 12b, the gNBs 222 perform measurements of the UL-PRS resources (sometimes referred to as “UL-PRS measurements”) transmitted by the UE 204 at stage 11.

The event and measurement reporting phase of the positioning procedure 900 begins at stage 13a. At stage 13a, the UE 204 transmits a random access preamble to the serving gNB 222(S) and in response, receives, at stage 13b, a random access response. At stage 14, the UE 204 sends an RRC Resume Request to the serving gNB 222(S) that includes an Event Report and the DL-PRS measurements performed at stage 12a (e.g., in an LPP Provide Location Information (PLI) message, as at stage 560 of FIG. 5). At stage 15, the serving gNB 222(S) forwards the Event Report to the anchor gNB 222(A) and the LMF 270. At stage 16, the LMF 270 receives one or more NRPPa Measurement Response messages from the involved gNBs 222 in the NG-RAN 220. At stage 17, the LMF 270 performs position-related calculations to estimate the location of the UE 204 based on the DL-PRS measurements and the UL-PRS measurements.

At stage 18a, the LMF 270 sends an NRPPa Positioning Deactivation Request to the gNBs 222. At stage 18b, the serving gNB 222(S) may optionally send an UL-PRS deactivation message to the UE 204. At stage 19, the LMF 270 sends an Event Report Acknowledgment to the gNBs 222. At stage 20, the serving gNB 222(S) sends an RRC Release message to the UE 204 that includes an Event Report Acknowledgement. At stage 21, the UE 204 performs stages 28 to 31 of the deferred 5GC-MT-LR procedure for periodic or triggered location events, as defined in 3GPP TS 23.273.

In some cases, the UE 204 can transmit the UL-PRS resources at stage 11, measure the DL-PRS at stage 12a, and report the DL-PRS measurements using the configured grant (CG) PUSCH. Alternatively, the UE 204 can resume the RRC connection and transmit the measurements and event report in an RRC Connected state, as illustrated in FIG. 9B.

It has been agreed that a DL-PRS configuration for RRC Inactive state positioning can be delivered to the UE in two ways: positioning SIB (posSIB) and LPP message while the UE is in an RRC Connected state. For the latter case, the UE can obtain a UE/cell-specific PRS configuration. However, due to the mobility of the UE in an RRC Inactive state, part of the PRS configuration may become invalid. For instance, when the UE moves out of a certain area, some previous PRS configurations may no longer be applicable, such as the priority indication of the TRPs to measure, the expected RSTD, etc. The priority of the TRP may be related to the location of the UE. For example, in order to ensure positioning accuracy, some TRPs around the cell where the UE is located can be indicated as high priority. However, as the UE moves in RRC Inactive state, a TRP with a previous high priority may be far away from the UE, and the TRP currently near the UE may be indicated as low priority. If the UE continues to use the previous priority rules for measurement and reporting, the positioning accuracy and efficiency may be affected. Therefore, the validity criteria for a PRS configuration in an RRC Inactive state delivered via LPP message in an RRC Connected state should be considered.

Accordingly, validity criteria for the PRS configuration to be used for RRC Inactive state positioning delivered via LPP message in an RRC Connected state should be considered. For example, the validity criteria for a UE/cell-specific PRS configuration may be related to the priority indication, the expected RSTD, etc.

In addition, it has also been agreed to support the pre-configuration of assistance data to the UE, at least in an LPP session (e.g., as illustrated in FIG. 5). The details of how to enable such a feature have not been defined (e.g., what additional functionality beyond a deferred location procedure might be needed). Further, it has been agreed that the LPP Request Location Information message can serve as an indication to the UE to utilize the pre-configured assistance data. Additional conditions and/or validity criteria for using the pre-configured assistance data have not been defined.

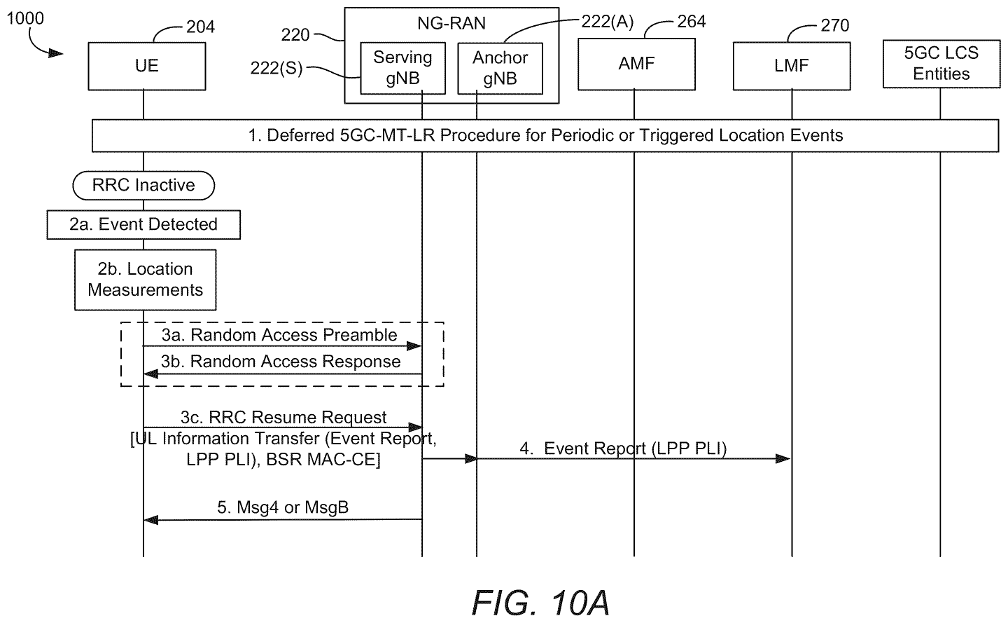

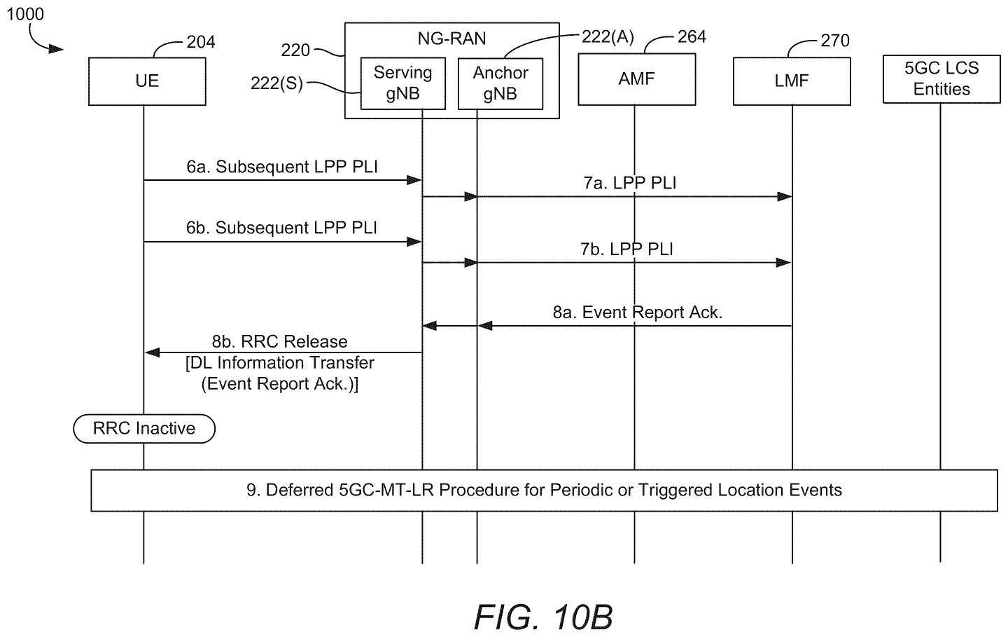

FIGS. 10A and 10B illustrate an example downlink-based positioning procedure 1000 for a UE in an RRC Inactive state, according to aspects of the disclosure. The downlink-based positioning procedure 1000 is similar to the downlink-and-uplink-based positioning procedure 900 but without the operations related to the uplink transmission and reception of UL-PRS.

At stage 1, stages 1 to 21 for the deferred 5GC-MT-LR procedure for periodic or triggered location events specified in 3GPP TS 23.273 are performed. The serving gNB 222(S) then sends an “RRCConnectionRelease” with “suspendConfig” to move the UE 204 to an RRC Inactive state. After performing these stages, the UE 204 would have been provided with the location request information (e.g., requested positioning method(s) and mode, QoS, etc.) and possibly any required assistance data (also referred to as “positioning assistance data,” a “set of positioning assistance data,” a “set of assistance data,” or the like). The UE 204 may request/receive additional/updated assistance data via posSI and/or LPP Request Assistance Data during the Event Reporting Phase as usual.

At stages 2a and 2b, the UE 204 monitors for occurrence of the triggered or periodic event requested during stage 1. The UE 204 determines which positioning method(s) will be used for the detected event from the request in stage 1 (based on the position method(s) included in an LPP Request Location Information message carried in the LCS Periodic-Triggered Invoke Request during stage 1). When the event is detected (or slightly before) the UE 204 performs the location measurements.

At stages 3a to 3c, if CG-SDT resources are not configured or cannot be selected, the UE 204 performs a two-step or four-step RACH procedure. In the case of a two-step RACH, the UE 204 includes an RRC Resume Request message in the PUSCH payload for MsgA. In the case of a four-step RACH, the UE 204 sends an RRC Resume Request message in the Msg3 to the serving gNB 222(S). Otherwise, if CG-SDT resources are configured on the selected uplink carrier and are valid, the UE 204 sends an RRC Resume Request message in the CG transmission to the serving gNB 222(S). The UE 204 sends an RRC UL Information Transfer message containing an UL NAS Transport message along with the RRC Resume Request. The UE 204 includes the LCS Event Report and LPP Provide Location Information (PLI) message in the payload container of the UL NAS Transport message, and the Deferred Routing Identifier received during stage 1 in the Additional Information of the UL NAS Transport message as defined in 3GPP TS 24.501 (which is publicly available and incorporated by reference herein in its entirety). The UE 204 sends an RRC Resume Request message along with the additional information on how many messages the UE has to send (e.g., similar to MAC-CE Buffer Status Report (BSR)). The embedded LPP PLI includes the “moreMessagesOn The Way” flag.

At stage 4, the serving gNB 222(S) sends the SS Event Report with the LPP PLI message to the LMF 270 (via the serving AMF 264 and possibly the anchor gNB 222(A)). At stage 5, the serving gNB 222(S) sends a Msg4 or MsgB to the UE 204.

At stages 6a and 6b, the UE 204 sends the additional LPP PLI message segments in the SDT subsequent data transmission phase. At stages 7a and 7b, the serving gNB 222(S) sends the LPP PLI message to the LMF 270 (via the serving AMF 264 and possibly the anchor gNB 222(A)).

At stage 8a, once the “noMoreMessages” flag in an LPP PLI has been received, the LMF 270 sends an SS Event Report Acknowledgement to the anchor gNB 222(A), which forwards the message to the serving gNB 222(S). The serving gNB 222(S) then provides the SS Event Report Acknowledgement to the UE 204 at stage 8b in a DL Information Transfer message along with the RRC Release message, which terminates the SDT procedure.

At stage 9, stages 28-31 for the deferred 5GC-MT-LR procedure for periodic or triggered location events specified in TS 23.273 are performed.

In the positioning procedure 1000, since the UE 204 can move away from the (last) gNB 222 where the UE received “suspendConfig” and camp in a different cell, the assistance data provided to the UE 204 may no longer be optimal. For example, at least the “NR-SelectedDL-PRS-IndexList” may need to be updated, if the size of “NR-DL-PRS-AssistanceData” is large enough to cover the RAN-based notification area (RNA). One option is to provide several configurations of assistance data (similar to what has been proposed with respect to an uplink-based procedure) and indicate which configuration is suitable at the current UE location. Another option is to provide the new configuration using SDT. In any case, RRC state transitions need to be reduced, if possible.

Accordingly, the present disclosure provides techniques for assistance data update procedures during RRC Idle or RRC Inactive positioning procedures. In each of the following techniques, a UE has sent a request for unicast assistance data (e.g., in an LPP Request Assistance Data message) inside which it included a cell ID. The UE has then received assistance data (e.g., in an LPP Provide Assistance Data message) while it was in an RRC Connected state. The UE has then transitioned to an RRC Inactive state where it performs downlink positioning measurements (e.g., RSTD, ToA, RSRP, etc.). The UE has then sent an RRC Resume Request message, as at stage 3c of FIG. 10A, which may include at least an “Event Report Information” message. Finally, the serving gNB has forwarded this information to the LMF, as at stage 4 of FIG. 10A.

As a first technique, on the LMF/network side, after the LMF 270 receives the forwarded information (i.e., Event Report) from an anchor gNB (a gNB from which the UE 204 receives pages while in RRC Inactive mode: a UE 204 could have multiple anchor gNBs 222(A) due to mobility), it uses the information included in that message to compare it against the previous assistance data and to determine whether the UE would benefit from new assistance data. If the answer is yes, it will inform the anchor gNB about this new assistance data (or a re-prioritization of the existing data). The anchor gNB will then report the new assistance data to the UE in the RRC Release message (e.g., at stage 8b of FIG. 10B) or in a Msg4 or MsgB (e.g., at stage 5 of FIG. 10A).

As a second technique, again on the LMF/network side, after the LMF receives the forwarded information (i.e., Event Report) from an anchor gNB, it implicitly determines what the new anchor gNB is by determining which gNB forwarded the message from the UE. The LMF compares the assistance data that would be associated with that gNB with the assistance data that was previously sent to the UE. The LMF then determines whether the UE would benefit from new assistance data. If the answer is yes, it will inform the anchor gNB about this new assistance data (or a re-prioritization of the existing data). The anchor gNB will then report the new assistance data to the UE in an RRC Release message (e.g., at stage 8b of FIG. 10B) or in a Msg4 or MsgB (e.g., at stage 5 of FIG. 10A).

As a third technique, on the UE side, the UE can include, in the RRC Resume Request at stage 3c of FIG. 10A, information that will help the LMF to determine whether the UE should receive new assistance data. This information may include (1) a flag (e.g., one bit) indicating whether the UE requires updated assistance data, (2) a collection of one or more cell IDs that it is observing/measuring in its vicinity, (3) an ID/timestamp of the assistance data that is actively being used at the UE up to this point, and/or (4) measurement qualities (e.g., RSRP, SINR, quality metric) for the reference TRP (for RSTD measurements) in the current assistance data, if not provided by the regular measurement report. For example, for RTT, DL-AoD positioning procedures, the UE does not typically provide this information. As such, it would be included in the report in a new information element (IE).

As a fourth technique, on the LMF/network side, the NG-RAN may determine that the UE has potentially moved (e.g., switched anchor cell). The NG-RAN therefore asks the LMF whether, for this new potential location of the UE, new assistance data should be sent. The LMF responds to the query either positively, with new assistance data (and an area/group-of-cells-validity, or expiration timer), or negatively. The NG-RAN receives the response from the LMF and sends a new paging message for this UE that informs the UE that new assistance data is available for this UE. The new assistance data may be sent to the UE either as a payload in the PDSCH of the page or in an RRC Release message (e.g., at stage 8b of FIG. 10B).

As a fifth technique, the LMF determines that the UE is in an RRC Inactive or Idle state and informs the NG-RAN of potential validity criteria involving the anchor gNB, area, cell IDs, etc. for different sets of assistance data. The NG-RAN determines that the UE has potentially moved to an area that satisfies the validity criteria for a given assistance data candidate. The NG-RAN sends a new paging message or an RRC release message to the UE that informs the UE that new assistance data is available. The new assistance data is then sent to the UE either as a payload in the PDSCH of the page or in an RRC Release message (e.g., at stage 8b of FIG. 10B).

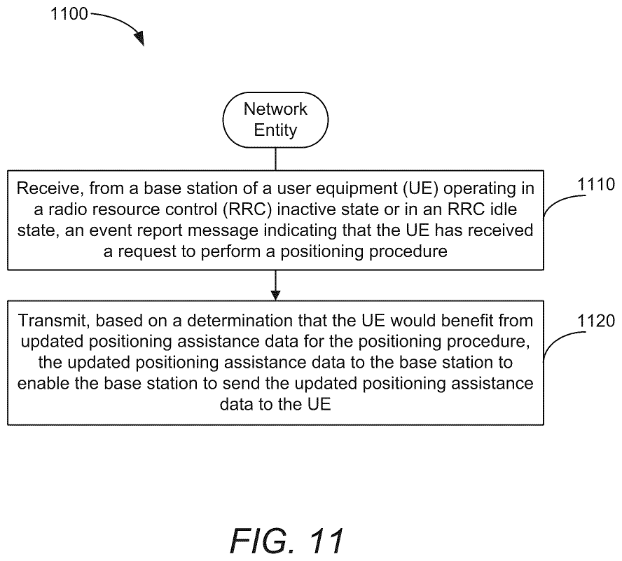

FIG. 11 illustrates an example method 1100 of positioning, according to aspects of the disclosure. In an aspect, method 1100 may be performed by a network entity (e.g., LMF 270).

At 1110, the network entity receives, from a base station (e.g., an anchor gNB 222) of a UE (e.g., UE 204) operating in an RRC inactive state or in an RRC idle state, an event report message indicating that the UE has received a request to perform a positioning procedure. In an aspect, operation 1110 may be performed by the one or more network transceivers 390, the one or more processors 394, memory 396, and/or positioning component 398, any or all of which may be considered means for performing this operation.

At 1120, the network entity transmits, based on a determination that the UE would benefit from updated positioning assistance data for the positioning procedure, the updated positioning assistance data to the base station to enable the base station to send the updated positioning assistance data to the UE. In an aspect, operation 1120 may be performed by the one or more network transceivers 390, the one or more processors 394, memory 396, and/or positioning component 398, any or all of which may be considered means for performing this operation.

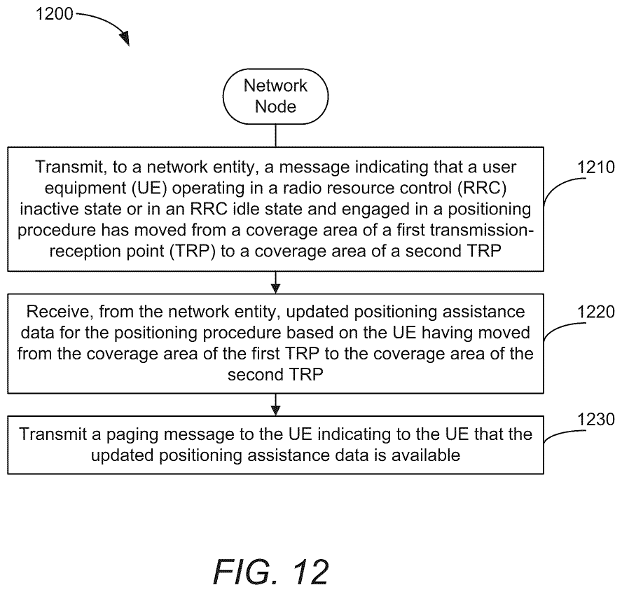

FIG. 12 illustrates an example method 1200 of positioning, according to aspects of the disclosure. In an aspect, method 1200 may be performed by a network node (e.g., a gNB 222).

At 1210, the network node transmits, to a network entity (e.g., LMF 270), a message indicating that a UE (e.g., UE 204) operating in an RRC inactive state or in an RRC idle state and engaged in a positioning procedure has moved from a coverage area of a first TRP (e.g., a TRP of any of the base stations described herein) to a coverage area of a second TRP. In an aspect, operation 1210 may be performed by the one or more network transceivers 380, the one or more processors 384, memory 386, and/or positioning component 388, any or all of which may be considered means for performing this operation.

At 1220, the network node receives, from the network entity, updated positioning assistance data for the positioning procedure based on the UE having moved from the coverage area of the first TRP to the coverage area of the second TRP. In an aspect, operation 1220 may be performed by the one or more network transceivers 380, the one or more processors 384, memory 386, and/or positioning component 388, any or all of which may be considered means for performing this operation.

At 1230, the network node transmits a paging message to the UE indicating to the UE that the updated positioning assistance data is available. In an aspect, operation 1230 may be performed by the one or more WWAN transceivers 350, the one or more processors 384, memory 386, and/or positioning component 388, any or all of which may be considered means for performing this operation.

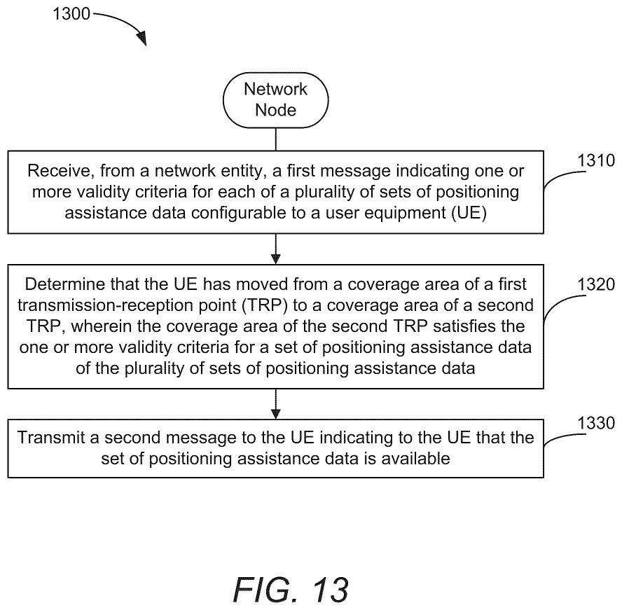

FIG. 13 illustrates an example method 1300 of positioning, according to aspects of the disclosure. In an aspect, method 1300 may be performed by a network node (e.g., a gNB 222).

At 1310, the network node receives, from a network entity (e.g., LMF 270), a first message indicating one or more validity criteria for each of a plurality of sets of positioning assistance data configurable to a UE (e.g., UE 204). In an aspect, operation 1310 may be performed by the one or more network transceivers 380, the one or more processors 384, memory 386, and/or positioning component 388, any or all of which may be considered means for performing this operation.

At 1320, the network node determines that the UE has moved from a coverage area of a first TRP (e.g., a TRP of any of the base stations described herein) to a coverage area of a second TRP, wherein the coverage area of the second TRP satisfies the one or more validity criteria for a set of positioning assistance data of the plurality of sets of positioning assistance data. In an aspect, operation 1320 may be performed by the one or more WWAN transceivers 350, the one or more network transceivers 380, the one or more processors 384, memory 386, and/or positioning component 388, any or all of which may be considered means for performing this operation.

At 1330, the network node transmits a second message to the UE indicating to the UE that the set of positioning assistance data is available. In an aspect, operation 1330 may be performed by the one or more WWAN transceivers 350, the one or more processors 384, memory 386, and/or positioning component 388, any or all of which may be considered means for performing this operation.

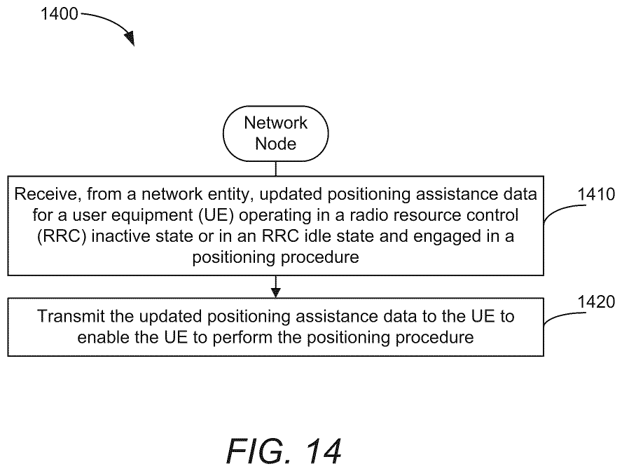

FIG. 14 illustrates an example method 1400 of positioning, according to aspects of the disclosure. In an aspect, method 1400 may be performed by a network node (e.g., a gNB 222).

At 1410, the network node receives, from a network entity (e.g., LMF 270), updated positioning assistance data for a UE (e.g., UE 204) operating in an RRC inactive state or in an RRC idle state and engaged in a positioning procedure. In an aspect, operation 1410 may be performed by the one or more network transceivers 380, the one or more processors 384, memory 386, and/or positioning component 388, any or all of which may be considered means for performing this operation.

At 1420, the network node transmits the updated positioning assistance data to the UE to enable the UE to perform the positioning procedure. In an aspect, operation 1420 may be performed by the one or more WWAN transceivers 350, the one or more processors 384, memory 386, and/or positioning component 388, any or all of which may be considered means for performing this operation.

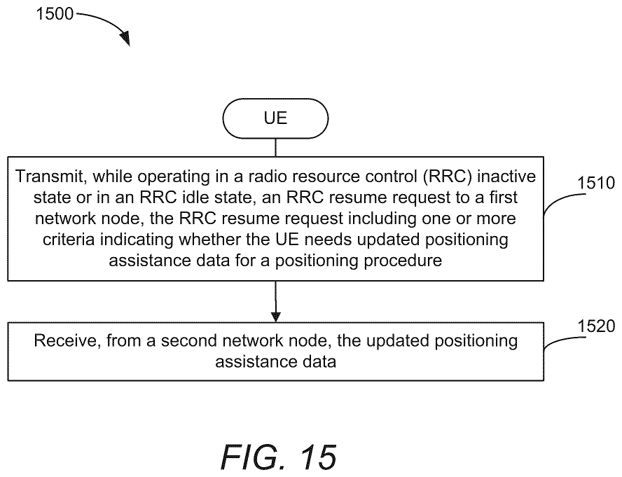

FIG. 15 illustrates an example method 1500 of wireless positioning, according to aspects of the disclosure. In an aspect, method 1500 may be performed by a UW (e.g., UE 204).

At 1510, the UE transmits, while operating in an RRC inactive state or in an RRC idle state, an RRC resume request to a first network node (e.g., a serving gNB 222), the RRC resume request including one or more criteria indicating whether the UE needs updated positioning assistance data for a positioning procedure. In an aspect, operation 1510 may be performed by the one or more WWAN transceivers 310, the one or more processors 332, memory 340, and/or positioning component 342, any or all of which may be considered means for performing this operation.

At 1520, the UE receives, from a second network node (e.g., an anchor gNB 222), the updated positioning assistance data. In an aspect, operation 1520 may be performed by the one or more WWAN transceivers 310, the one or more processors 332, memory 340, and/or positioning component 342, any or all of which may be considered means for performing this operation.

As will be appreciated, a technical advantage of the methods 1100 to 1500 is providing a UE with updated positioning assistance data due to the UE's mobility while in an RRC Inactive state or in an RRC idle state.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of positioning performed by a network entity, comprising: receiving, from a base station of a user equipment (UE) operating in a radio resource control (RRC) inactive state or in an RRC idle state, an event report message indicating that the UE has received a request to perform a positioning procedure; and transmitting, based on a determination that the UE would benefit from updated positioning assistance data for the positioning procedure, the updated positioning assistance data to the base station to enable the base station to send the updated positioning assistance data to the UE.

Clause 2. The method of clause 1, wherein the updated positioning assistance data comprises: new positioning assistance data, a re-prioritization of positioning assistance data previously configured to the UE, or any combination thereof.

Clause 3. The method of any of clauses 1 to 2, wherein the determination that the UE would benefit from updated positioning assistance data is based on a comparison of positioning assistance data previously configured to the UE to information in the event report message.

Clause 4. The method of clause 3, wherein the information in the event report message includes at least a cell identifier associated with the base station.

Clause 5. The method of any of clauses 1 to 4, wherein: the base station is an anchor base station for the UE, and the determination that the UE would benefit from updated positioning assistance data is based on a comparison of positioning assistance data previously configured to the UE to positioning assistance data that would be provided to the UE based on the UE being in a coverage area of the anchor base station.

Clause 6. The method of any of clauses 1 to 5, wherein the network entity is a location server.

Clause 7. A method of positioning performed by a network node, comprising: transmitting, to a network entity, a message indicating that a user equipment (UE) operating in a radio resource control (RRC) inactive state or in an RRC idle state and engaged in a positioning procedure has moved from a coverage area of a first transmission-reception point (TRP) to a coverage area of a second TRP: receiving, from the network entity, updated positioning assistance data for the positioning procedure based on the UE having moved from the coverage area of the first TRP to the coverage area of the second TRP; and transmitting a paging message to the UE indicating to the UE that the updated positioning assistance data is available.

Clause 8. The method of clause 7, further comprising: transmitting the updated positioning assistance data to the UE in a payload of the paging message.

Clause 9. The method of clause 7, further comprising: transmitting the updated positioning assistance data to the UE in an RRC release message.

Clause 10. The method of any of clauses 7 to 9, further comprising: receiving, from the network entity, an indication of an area, a group of cells for which the updated positioning assistance data is valid, an expiration timer associated with the updated positioning assistance data, or any combination thereof.

Clause 11. The method of any of clauses 7 to 10, wherein: the network node is a base station, and the network entity is a location server.

Clause 12. A method of positioning performed by a network node, comprising: receiving, from a network entity, a first message indicating one or more validity criteria for each of a plurality of sets of positioning assistance data configurable to a user equipment (UE); determining that the UE has moved from a coverage area of a first transmission-reception point (TRP) to a coverage area of a second TRP, wherein the coverage area of the second TRP satisfies the one or more validity criteria for a set of positioning assistance data of the plurality of sets of positioning assistance data; and transmitting a second message to the UE indicating to the UE that the set of positioning assistance data is available.

Clause 13. The method of clause 12, wherein the second message is a paging message.

Clause 14. The method of clause 13, further comprising: transmitting the set of positioning assistance data to the UE in a payload of the paging message.

Clause 15. The method of clause 12, wherein the second message is an RRC release message.

Clause 16. The method of any of clauses 12 to 15, further comprising: transmitting the set of positioning assistance data to the UE in an RRC release message.

Clause 17. The method of any of clauses 12 to 16, wherein the one or more validity criteria comprise: an identifier of an anchor base station, an area, one or more cell identifiers, or any combination thereof.

Clause 18. The method of any of clauses 12 to 17, wherein: the network node is a base station, and the network entity is a location server.

Clause 19. A method of positioning performed by a network node, comprising: receiving, from a network entity, updated positioning assistance data for a user equipment (UE) operating in a radio resource control (RRC) inactive state or in an RRC idle state and engaged in a positioning procedure; and transmitting the updated positioning assistance data to the UE to enable the UE to perform the positioning procedure.

Clause 20. The method of clause 19, further comprising: receiving, from the UE, an event report message indicating that the UE has received a request to perform the positioning procedure; and forwarding the event report message to the network entity, wherein the updated positioning assistance data is received in response to the event report message.

Clause 21. The method of any of clauses 19 to 20, wherein the updated positioning assistance data is transmitted in an RRC release message.

Clause 22. The method of any of clauses 19 to 20, wherein the updated positioning assistance data is transmitted in a final message of a random access procedure.

Clause 23. The method of any of clauses 19 to 22, wherein: the network node is an anchor base station for the UE, and the network entity is a location server.

Clause 24. A method of wireless positioning performed by a user equipment (UE), comprising: transmitting, while operating in a radio resource control (RRC) inactive state or in an RRC idle state, an RRC resume request to a first network node, the RRC resume request including one or more criteria indicating whether the UE needs updated positioning assistance data for a positioning procedure; and receiving, from a second network node, the updated positioning assistance data.

Clause 25. The method of clause 24, wherein the one or more criteria comprise: a flag indicating that the UE needs new positioning assistance data, one or more cell identifiers that the UE has detected at its current location, an identifier associated with positioning assistance data currently being used by the UE for the positioning procedure, a timestamp associated with the positioning assistance data currently being used by the UE for the positioning procedure, a measurement quality of a reference transmission-reception point (TRP) in the positioning assistance data currently being used by the UE for the positioning procedure, or any combination thereof.

Clause 26. The method of clause 25, further comprising: receiving the positioning assistance data currently being used by the UE for the positioning procedure while in an RRC connected state.

Clause 27. The method of any of clauses 24 to 26, wherein the RRC resume request includes an event report message indicating that the UE has received a request to perform the positioning procedure.

Clause 28. The method of any of clauses 24 to 27, wherein: the first network node is a serving base station of the UE, and the second network node is an anchor base station for the UE.

Clause 29. The method of any of clauses 24 to 28, wherein the first network node and the second network node are the same network node.

Clause 30. The method of any of clauses 24 to 29, further comprising: performing, while in the RRC inactive state or in the RRC idle state, positioning measurement of downlink positioning reference signals (PRS) based on the updated positioning assistance data.

Clause 31. A network entity, comprising: a memory: at least one transceiver; and at least one processor communicatively coupled to the memory and the at least one transceiver, the at least one processor configured to: receive, via the at least one transceiver, from a base station of a user equipment (UE) operating in a radio resource control (RRC) inactive state or in an RRC idle state, an event report message indicating that the UE has received a request to perform a positioning procedure; and transmit, via the at least one transceiver, based on a determination that the UE would benefit from updated positioning assistance data for the positioning procedure, the updated positioning assistance data to the base station to enable the base station to send the updated positioning assistance data to the UE.

Clause 32. The network entity of clause 31, wherein the updated positioning assistance data comprises: new positioning assistance data, a re-prioritization of positioning assistance data previously configured to the UE, or any combination thereof.

Clause 33. The network entity of any of clauses 31 to 32, wherein the determination that the UE would benefit from updated positioning assistance data is based on a comparison of positioning assistance data previously configured to the UE to information in the event report message.

Clause 34. The network entity of clause 33, wherein the information in the event report message includes at least a cell identifier associated with the base station.

Clause 35. The network entity of any of clauses 31 to 34, wherein: the base station is an anchor base station for the UE, and the determination that the UE would benefit from updated positioning assistance data is based on a comparison of positioning assistance data previously configured to the UE to positioning assistance data that would be provided to the UE based on the UE being in a coverage area of the anchor base station.

Clause 36. The network entity of any of clauses 31 to 35, wherein the network entity is a location server.

Clause 37. A network node, comprising: a memory; at least one transceiver; and at least one processor communicatively coupled to the memory and the at least one transceiver, the at least one processor configured to: transmit, via the at least one transceiver, to a network entity, a message indicating that a user equipment (UE) operating in a radio resource control (RRC) inactive state or in an RRC idle state and engaged in a positioning procedure has moved from a coverage area of a first transmission-reception point (TRP) to a coverage area of a second TRP; receive, via the at least one transceiver, from the network entity, updated positioning assistance data for the positioning procedure based on the UE having moved from the coverage area of the first TRP to the coverage area of the second TRP; and transmit, via the at least one transceiver, a paging message to the UE indicating to the UE that the updated positioning assistance data is available.

Clause 38. The network node of clause 37, wherein the at least one processor is further configured to: transmit, via the at least one transceiver, the updated positioning assistance data to the UE in a payload of the paging message.

Clause 39. The network node of clause 37, wherein the at least one processor is further configured to: transmit, via the at least one transceiver, the updated positioning assistance data to the UE in an RRC release message.

Clause 40. The network node of any of clauses 37 to 39, wherein the at least one processor is further configured to: receive, via the at least one transceiver, from the network entity, an indication of an area, a group of cells for which the updated positioning assistance data is valid, an expiration timer associated with the updated positioning assistance data, or any combination thereof.

Clause 41. The network node of any of clauses 37 to 40, wherein: the network node is a base station, and the network entity is a location server.

Clause 42. A network node, comprising: a memory: at least one transceiver; and at least one processor communicatively coupled to the memory and the at least one transceiver, the at least one processor configured to: receive, via the at least one transceiver, from a network entity, a first message indicating one or more validity criteria for each of a plurality of sets of positioning assistance data configurable to a user equipment (UE): determine that the UE has moved from a coverage area of a first transmission-reception point (TRP) to a coverage area of a second TRP, wherein the coverage area of the second TRP satisfies the one or more validity criteria for a set of positioning assistance data of the plurality of sets of positioning assistance data; and transmit, via the at least one transceiver, a second message to the UE indicating to the UE that the set of positioning assistance data is available.

Clause 43. The network node of clause 42, wherein the second message is a paging message.

Clause 44. The network node of clause 43, wherein the at least one processor is further configured to: transmit, via the at least one transceiver, the set of positioning assistance data to the UE in a payload of the paging message.

Clause 45. The network node of clause 42, wherein the second message is an RRC release message.

Clause 46. The network node of any of clauses 42 to 45, wherein the at least one processor is further configured to: transmit, via the at least one transceiver, the set of positioning assistance data to the UE in an RRC release message.

Clause 47. The network node of any of clauses 42 to 46, wherein the one or more validity criteria comprise: an identifier of an anchor base station, an area, one or more cell identifiers, or any combination thereof.

Clause 48. The network node of any of clauses 42 to 47, wherein: the network node is a base station, and the network entity is a location server.

Clause 49. A network node, comprising: a memory; at least one transceiver; and at least one processor communicatively coupled to the memory and the at least one transceiver, the at least one processor configured to: receive, via the at least one transceiver, from a network entity, updated positioning assistance data for a user equipment (UE) operating in a radio resource control (RRC) inactive state or in an RRC idle state and engaged in a positioning procedure; and transmit, via the at least one transceiver, the updated positioning assistance data to the UE to enable the UE to perform the positioning procedure.

Clause 50. The network node of clause 49, wherein the at least one processor is further configured to: receive, via the at least one transceiver, from the UE, an event report message indicating that the UE has received a request to perform the positioning procedure; and forward the event report message to the network entity, wherein the updated positioning assistance data is received in response to the event report message.

Clause $1. The network node of any of clauses 49 to 50, wherein the updated positioning assistance data is transmitted in an RRC release message.

Clause 52. The network node of any of clauses 49 to 50, wherein the updated positioning assistance data is transmitted in a final message of a random access procedure.

Clause 53. The network node of any of clauses 49 to 52, wherein: the network node is an anchor base station for the UE, and the network entity is a location server.

Clause 54. A user equipment (UE), comprising: a memory: at least one transceiver; and at least one processor communicatively coupled to the memory and the at least one transceiver, the at least one processor configured to: transmit, via the at least one transceiver, while operating in a radio resource control (RRC) inactive state or in an RRC idle state, an RRC resume request to a first network node, the RRC resume request including one or more criteria indicating whether the UE needs updated positioning assistance data for a positioning procedure; and receive, via the at least one transceiver, from a second network node, the updated positioning assistance data.

Clause 55. The UE of clause 54, wherein the one or more criteria comprise: a flag indicating that the UE needs new positioning assistance data, one or more cell identifiers that the UE has detected at its current location, an identifier associated with positioning assistance data currently being used by the UE for the positioning procedure, a timestamp associated with the positioning assistance data currently being used by the UE for the positioning procedure, a measurement quality of a reference transmission-reception point (TRP) in the positioning assistance data currently being used by the UE for the positioning procedure, or any combination thereof.

Clause 56. The UE of clause 55, wherein the at least one processor is further configured to: receive, via the at least one transceiver, the positioning assistance data currently being used by the UE for the positioning procedure while in an RRC connected state.

Clause 57. The UE of any of clauses 54 to 56, wherein the RRC resume request includes an event report message indicating that the UE has received a request to perform the positioning procedure.

Clause 58. The UE of any of clauses 54 to 57, wherein: the first network node is a serving base station of the UE, and the second network node is an anchor base station for the UE.

Clause 59. The UE of any of clauses $4 to 58, wherein the first network node and the second network node are the same network node.

Clause 60. The UE of any of clauses 54 to 59, wherein the at least one processor is further configured to: perform, while in the RRC inactive state or in the RRC idle state, positioning measurement of downlink positioning reference signals (PRS) based on the updated positioning assistance data.

Clause 61. A network entity, comprising: means for receiving, from a base station of a user equipment (UE) operating in a radio resource control (RRC) inactive state or in an RRC idle state, an event report message indicating that the UE has received a request to perform a positioning procedure; and means for transmitting, based on a determination that the UE would benefit from updated positioning assistance data for the positioning procedure, the updated positioning assistance data to the base station to enable the base station to send the updated positioning assistance data to the UE.

Clause 62. The network entity of clause 61, wherein the updated positioning assistance data comprises: new positioning assistance data, a re-prioritization of positioning assistance data previously configured to the UE, or any combination thereof.

Clause 63. The network entity of any of clauses 61 to 62, wherein the determination that the UE would benefit from updated positioning assistance data is based on a comparison of positioning assistance data previously configured to the UE to information in the event report message.

Clause 64. The network entity of clause 63, wherein the information in the event report message includes at least a cell identifier associated with the base station.

Clause 65. The network entity of any of clauses 61 to 64, wherein: the base station is an anchor base station for the UE, and the determination that the UE would benefit from updated positioning assistance data is based on a comparison of positioning assistance data previously configured to the UE to positioning assistance data that would be provided to the UE based on the UE being in a coverage area of the anchor base station.

Clause 66. The network entity of any of clauses 61 to 65, wherein the network entity is a location server.

Clause 67. A network node, comprising: means for transmitting, to a network entity, a message indicating that a user equipment (UE) operating in a radio resource control (RRC) inactive state or in an RRC idle state and engaged in a positioning procedure has moved from a coverage area of a first transmission-reception point (TRP) to a coverage area of a second TRP: means for receiving, from the network entity, updated positioning assistance data for the positioning procedure based on the UE having moved from the coverage area of the first TRP to the coverage area of the second TRP; and means for transmitting a paging message to the UE indicating to the UE that the updated positioning assistance data is available.

Clause 68. The network node of clause 67, further comprising: means for transmitting the updated positioning assistance data to the UE in a payload of the paging message.

Clause 69. The network node of clause 67, further comprising: means for transmitting the updated positioning assistance data to the UE in an RRC release message.

Clause 70. The network node of any of clauses 67 to 69, further comprising: means for receiving, from the network entity, an indication of an area, a group of cells for which the updated positioning assistance data is valid, an expiration timer associated with the updated positioning assistance data, or any combination thereof.

Clause 71. The network node of any of clauses 67 to 70, wherein: the network node is a base station, and the network entity is a location server.

Clause 72. A network node, comprising: means for receiving, from a network entity, a first message indicating one or more validity criteria for each of a plurality of sets of positioning assistance data configurable to a user equipment (UE): means for determining that the UE has moved from a coverage area of a first transmission-reception point (TRP) to a coverage area of a second TRP, wherein the coverage area of the second TRP satisfies the one or more validity criteria for a set of positioning assistance data of the plurality of sets of positioning assistance data; and means for transmitting a second message to the UE indicating to the UE that the set of positioning assistance data is available.

Clause 73. The network node of clause 72, wherein the second message is a paging message.

Clause 74. The network node of clause 73, further comprising: means for transmitting the set of positioning assistance data to the UE in a payload of the paging message.

Clause 75. The network node of clause 72, wherein the second message is an RRC release message.

Clause 76. The network node of any of clauses 72 to 75, further comprising: means for transmitting the set of positioning assistance data to the UE in an RRC release message.

Clause 77. The network node of any of clauses 72 to 76, wherein the one or more validity criteria comprise: an identifier of an anchor base station, an area, one or more cell identifiers, or any combination thereof.

Clause 78. The network node of any of clauses 72 to 77, wherein: the network node is a base station, and the network entity is a location server.

Clause 79. A network node, comprising: means for receiving, from a network entity, updated positioning assistance data for a user equipment (UE) operating in a radio resource control (RRC) inactive state or in an RRC idle state and engaged in a positioning procedure; and means for transmitting the updated positioning assistance data to the UE to enable the UE to perform the positioning procedure.

Clause 80. The network node of clause 79, further comprising: means for receiving, from the UE, an event report message indicating that the UE has received a request to perform the positioning procedure; and means for forwarding the event report message to the network entity, wherein the updated positioning assistance data is received in response to the event report message.

Clause 81. The network node of any of clauses 79 to 80, wherein the updated positioning assistance data is transmitted in an RRC release message.

Clause 82. The network node of any of clauses 79 to 80, wherein the updated positioning assistance data is transmitted in a final message of a random access procedure.

Clause 83. The network node of any of clauses 79 to 82, wherein: the network node is an anchor base station for the UE, and the network entity is a location server.

Clause 84. A user equipment (UE), comprising: means for transmitting, while operating in a radio resource control (RRC) inactive state or in an RRC idle state, an RRC resume request to a first network node, the RRC resume request including one or more criteria indicating whether the UE needs updated positioning assistance data for a positioning procedure; and means for receiving, from a second network node, the updated positioning assistance data.

Clause 85. The UE of clause 84, wherein the one or more criteria comprise: a flag indicating that the UE needs new positioning assistance data, one or more cell identifiers that the UE has detected at its current location, an identifier associated with positioning assistance data currently being used by the UE for the positioning procedure, a timestamp associated with the positioning assistance data currently being used by the UE for the positioning procedure, a measurement quality of a reference transmission-reception point (TRP) in the positioning assistance data currently being used by the UE for the positioning procedure, or any combination thereof.

Clause 86. The UE of clause 85, further comprising: means for receiving the positioning assistance data currently being used by the UE for the positioning procedure while in an RRC connected state.

Clause 87. The UE of any of clauses 84 to 86, wherein the RRC resume request includes an event report message indicating that the UE has received a request to perform the positioning procedure.

Clause 88. The UE of any of clauses 84 to 87, wherein: the first network node is a serving base station of the UE, and the second network node is an anchor base station for the UE.

Clause 89. The UE of any of clauses 84 to 88, wherein the first network node and the second network node are the same network node.

Clause 90. The UE of any of clauses 84 to 89, further comprising: means for performing, while in the RRC inactive state or in the RRC idle state, positioning measurement of downlink positioning reference signals (PRS) based on the updated positioning assistance data.

Clause 91. A non-transitory computer-readable medium storing computer-executable instructions that, when executed by a network entity, cause the network entity to: receive, from a base station of a user equipment (UE) operating in a radio resource control (RRC) inactive state or in an RRC idle state, an event report message indicating that the UE has received a request to perform a positioning procedure; and transmit, based on a determination that the UE would benefit from updated positioning assistance data for the positioning procedure, the updated positioning assistance data to the base station to enable the base station to send the updated positioning assistance data to the UE.

Clause 92. The non-transitory computer-readable medium of clause 91, wherein the updated positioning assistance data comprises: new positioning assistance data, a re-prioritization of positioning assistance data previously configured to the UE, or any combination thereof.

Clause 93. The non-transitory computer-readable medium of any of clauses 91 to 92, wherein the determination that the UE would benefit from updated positioning assistance data is based on a comparison of positioning assistance data previously configured to the UE to information in the event report message.

Clause 94. The non-transitory computer-readable medium of clause 93, wherein the information in the event report message includes at least a cell identifier associated with the base station.

Clause 95. The non-transitory computer-readable medium of any of clauses 91 to 94, wherein: the base station is an anchor base station for the UE, and the determination that the UE would benefit from updated positioning assistance data is based on a comparison of positioning assistance data previously configured to the UE to positioning assistance data that would be provided to the UE based on the UE being in a coverage area of the anchor base station.

Clause 96. The non-transitory computer-readable medium of any of clauses 91 to 95, wherein the network entity is a location server.

Clause 97. A non-transitory computer-readable medium storing computer-executable instructions that, when executed by a network node, cause the network node to: transmit, to a network entity, a message indicating that a user equipment (UE) operating in a radio resource control (RRC) inactive state or in an RRC idle state and engaged in a positioning procedure has moved from a coverage area of a first transmission-reception point (TRP) to a coverage area of a second TRP; receive, from the network entity, updated positioning assistance data for the positioning procedure based on the UE having moved from the coverage area of the first TRP to the coverage area of the second TRP; and transmit a paging message to the UE indicating to the UE that the updated positioning assistance data is available.

Clause 98. The non-transitory computer-readable medium of clause 97, further comprising computer-executable instructions that, when executed by the network node, cause the network node to: transmit the updated positioning assistance data to the UE in a payload of the paging message.

Clause 99. The non-transitory computer-readable medium of clause 97, further comprising computer-executable instructions that, when executed by the network node, cause the network node to: transmit the updated positioning assistance data to the UE in an RRC release message.

Clause 100. The non-transitory computer-readable medium of any of clauses 97 to 99, further comprising computer-executable instructions that, when executed by the network node, cause the network node to: receive, from the network entity, an indication of an area, a group of cells for which the updated positioning assistance data is valid, an expiration timer associated with the updated positioning assistance data, or any combination thereof.

Clause 101. The non-transitory computer-readable medium of any of clauses 97 to 100, wherein: the network node is a base station, and the network entity is a location server.

Clause 102. A non-transitory computer-readable medium storing computer-executable instructions that, when executed by a network node, cause the network node to: receive, from a network entity, a first message indicating one or more validity criteria for each of a plurality of sets of positioning assistance data configurable to a user equipment (UE): determine that the UE has moved from a coverage area of a first transmission-reception point (TRP) to a coverage area of a second TRP, wherein the coverage area of the second TRP satisfies the one or more validity criteria for a set of positioning assistance data of the plurality of sets of positioning assistance data; and transmit a second message to the UE indicating to the UE that the set of positioning assistance data is available.

Clause 103. The non-transitory computer-readable medium of clause 102, wherein the second message is a paging message.

Clause 104. The non-transitory computer-readable medium of clause 103, further comprising computer-executable instructions that, when executed by the network node, cause the network node to: transmit the set of positioning assistance data to the UE in a payload of the paging message.

Clause 105. The non-transitory computer-readable medium of clause 102, wherein the second message is an RRC release message.

Clause 106. The non-transitory computer-readable medium of any of clauses 102 to 105, further comprising computer-executable instructions that, when executed by the network node, cause the network node to: transmit the set of positioning assistance data to the UE in an RRC release message.

Clause 107. The non-transitory computer-readable medium of any of clauses 102 to 106, wherein the one or more validity criteria comprise: an identifier of an anchor base station, an area, one or more cell identifiers, or any combination thereof.

Clause 108. The non-transitory computer-readable medium of any of clauses 102 to 107, wherein: the network node is a base station, and the network entity is a location server.

Clause 109. A non-transitory computer-readable medium storing computer-executable instructions that, when executed by a network node, cause the network node to: receive, from a network entity, updated positioning assistance data for a user equipment (UE) operating in a radio resource control (RRC) inactive state or in an RRC idle state and engaged in a positioning procedure; and transmit the updated positioning assistance data to the UE to enable the UE to perform the positioning procedure.

Clause 110. The non-transitory computer-readable medium of clause 109, further comprising computer-executable instructions that, when executed by the network node, cause the network node to: receive, from the UE, an event report message indicating that the UE has received a request to perform the positioning procedure; and forward the event report message to the network entity, wherein the updated positioning assistance data is received in response to the event report message.

Clause 111. The non-transitory computer-readable medium of any of clauses 109 to 110, wherein the updated positioning assistance data is transmitted in an RRC release message.

Clause 112. The non-transitory computer-readable medium of any of clauses 109 to 110, wherein the updated positioning assistance data is transmitted in a final message of a random access procedure.

Clause 113. The non-transitory computer-readable medium of any of clauses 109 to 112, wherein: the network node is an anchor base station for the UE, and the network entity is a location server.

Clause 114. A non-transitory computer-readable medium storing computer-executable instructions that, when executed by a user equipment (UE), cause the UE to: transmit, while operating in a radio resource control (RRC) inactive state or in an RRC idle state, an RRC resume request to a first network node, the RRC resume request including one or more criteria indicating whether the UE needs updated positioning assistance data for a positioning procedure; and receive, from a second network node, the updated positioning assistance data.

Clause 115. The non-transitory computer-readable medium of clause 114, wherein the one or more criteria comprise: a flag indicating that the UE needs new positioning assistance data, one or more cell identifiers that the UE has detected at its current location, an identifier associated with positioning assistance data currently being used by the UE for the positioning procedure, a timestamp associated with the positioning assistance data currently being used by the UE for the positioning procedure, a measurement quality of a reference transmission-reception point (TRP) in the positioning assistance data currently being used by the UE for the positioning procedure, or any combination thereof.

Clause 116. The non-transitory computer-readable medium of clause 115, further comprising computer-executable instructions that, when executed by the UE, cause the UE to: receive the positioning assistance data currently being used by the UE for the positioning procedure while in an RRC connected state.

Clause 117. The non-transitory computer-readable medium of any of clauses 114 to 116, wherein the RRC resume request includes an event report message indicating that the UE has received a request to perform the positioning procedure.

Clause 118. The non-transitory computer-readable medium of any of clauses 114 to 117, wherein: the first network node is a serving base station of the UE, and the second network node is an anchor base station for the UE.

Clause 119. The non-transitory computer-readable medium of any of clauses 114 to 118, wherein the first network node and the second network node are the same network node.

Clause 120. The non-transitory computer-readable medium of any of clauses 114 to 119, further comprising computer-executable instructions that, when executed by the UE, cause the UE to: perform, while in the RRC inactive state or in the RRC idle state, positioning measurement of downlink positioning reference signals (PRS) based on the updated positioning assistance data.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM. EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1-30. (canceled)

31. A network entity, comprising:
a memory;
at least one transceiver; and
at least one processor communicatively coupled to the memory and the at least one transceiver, the at least one processor configured to:
receive, via the at least one transceiver, from a base station of a user equipment (UE) operating in a radio resource control (RRC) inactive state or in an RRC idle state, an event report message indicating that the UE has received a request to perform a positioning procedure; and
transmit, via the at least one transceiver, based on a determination that the UE would benefit from updated positioning assistance data for the positioning procedure, the updated positioning assistance data to the base station to enable the base station to send the updated positioning assistance data to the UE.

32. The network entity of claim 31, wherein the updated positioning assistance data comprises:
new positioning assistance data,
a re-prioritization of positioning assistance data previously configured to the UE, or any combination thereof.

33. The network entity of claim 31, wherein the determination that the UE would benefit from updated positioning assistance data is based on a comparison of positioning assistance data previously configured to the UE to information in the event report message.

34. The network entity of claim 33, wherein the information in the event report message includes at least a cell identifier associated with the base station.

35. The network entity of claim 31, wherein:
the base station is an anchor base station for the UE, and
the determination that the UE would benefit from updated positioning assistance data is based on a comparison of positioning assistance data previously configured to the UE to positioning assistance data that would be provided to the UE based on the UE being in a coverage area of the anchor base station.

36. The network entity of claim 31, wherein the network entity is a location server.

37. A network node, comprising:
a memory;
at least one transceiver; and
at least one processor communicatively coupled to the memory and the at least one transceiver, the at least one processor configured to:
transmit, via the at least one transceiver, to a network entity, a message indicating that a user equipment (UE) operating in a radio resource control (RRC) inactive state or in an RRC idle state and engaged in a positioning procedure has moved from a coverage area of a first transmission-reception point (TRP) to a coverage area of a second TRP;
receive, via the at least one transceiver, from the network entity, updated positioning assistance data for the positioning procedure based on the UE having moved from the coverage area of the first TRP to the coverage area of the second TRP; and
transmit, via the at least one transceiver, a paging message to the UE indicating to the UE that the updated positioning assistance data is available.

38. The network node of claim 37, wherein the at least one processor is further configured to:
transmit, via the at least one transceiver, the updated positioning assistance data to the UE in a payload of the paging message.

39. The network node of claim 37, wherein the at least one processor is further configured to:
transmit, via the at least one transceiver, the updated positioning assistance data to the UE in an RRC release message.

40. The network node of claim 37, wherein the at least one processor is further configured to:
receive, via the at least one transceiver, from the network entity, an indication of an area, a group of cells for which the updated positioning assistance data is valid, an expiration timer associated with the updated positioning assistance data, or any combination thereof.

41. The network node of claim 37, wherein:
the network node is a base station, and
the network entity is a location server.

42. A network node, comprising:
a memory;
at least one transceiver; and
at least one processor communicatively coupled to the memory and the at least one transceiver, the at least one processor configured to:
receive, via the at least one transceiver, from a network entity, a first message indicating one or more validity criteria for each of a plurality of sets of positioning assistance data configurable to a user equipment (UE);
determine that the UE has moved from a coverage area of a first transmission-reception point (TRP) to a coverage area of a second TRP, wherein the coverage area of the second TRP satisfies the one or more validity criteria for a set of positioning assistance data of the plurality of sets of positioning assistance data; and
transmit, via the at least one transceiver, a second message to the UE indicating to the UE that the set of positioning assistance data is available.

43. The network node of claim 42, wherein the second message is a paging message.

44. The network node of claim 43, wherein the at least one processor is further configured to:
transmit, via the at least one transceiver, the set of positioning assistance data to the UE in a payload of the paging message.

45. The network node of claim 42, wherein the second message is an RRC release message.

46. The network node of claim 42, wherein the at least one processor is further configured to:
transmit, via the at least one transceiver, the set of positioning assistance data to the UE in an RRC release message.

47. The network node of claim 42, wherein the one or more validity criteria comprise:
an identifier of an anchor base station,
an area,
one or more cell identifiers, or
any combination thereof.

48. The network node of claim 42, wherein:
the network node is a base station, and
the network entity is a location server.

49-53. (canceled)

54. A user equipment (UE), comprising:
a memory;
at least one transceiver; and
at least one processor communicatively coupled to the memory and the at least one transceiver, the at least one processor configured to:
transmit, via the at least one transceiver, while operating in a radio resource control (RRC) inactive state or in an RRC idle state, an RRC resume request to a first network node, the RRC resume request including one or more criteria indicating whether the UE needs updated positioning assistance data for a positioning procedure; and
receive, via the at least one transceiver, from a second network node, the updated positioning assistance data.

55. The UE of claim 54, wherein the one or more criteria comprise:
a flag indicating that the UE needs new positioning assistance data,
one or more cell identifiers that the UE has detected at its current location,
an identifier associated with positioning assistance data currently being used by the UE for the positioning procedure,
a timestamp associated with the positioning assistance data currently being used by the UE for the positioning procedure,
a measurement quality of a reference transmission-reception point (TRP) in the positioning assistance data currently being used by the UE for the positioning procedure, or
any combination thereof.

56. The UE of claim 55, wherein the at least one processor is further configured to:
receive, via the at least one transceiver, the positioning assistance data currently being used by the UE for the positioning procedure while in an RRC connected state.

57. The UE of claim 54, wherein the RRC resume request includes an event report message indicating that the UE has received a request to perform the positioning procedure.

58. The UE of claim 54, wherein:
the first network node is a serving base station of the UE, and
the second network node is an anchor base station for the UE.

59. The UE of claim 54, wherein the first network node and the second network node are the same network node.

60. The UE of claim 54, wherein the at least one processor is further configured to:
perform, while in the RRC inactive state or in the RRC idle state, positioning measurement of downlink positioning reference signals (PRS) based on the updated positioning assistance data.
